(19) United States
(12) Patent Application Publication
(10) Pub. No.: US 2022/0402528 A1
(43) Pub. Date: Dec. 22, 2022

(54) Battery-Electric Long Range Line Haul Locomotive, Recharging Infrastructure and Method of Operation

(71) Applicant: Michael A. Gura, Irvine, CA (US)

(72) Inventor: Michael A. Gura, Irvine, CA (US)

(21) Appl. No.: 17/824,270

(22) Filed: May 25, 2022

Related U.S. Application Data
(60) Provisional application No. 63/259,072, filed on Jun. 21, 2021.

(51) Int. Cl. B61C 3/02

(52) U.S. Cl. CPC B61C 3/02

(57) ABSTRACT

Long range, zero emission, battery-electric line haul locomotive, off-grid renewable energy recharging infrastructure and method of operation are presented. Proposed battery-electric locomotive (Neon Zero) designed to exceed performance and operational capabilities of current state-of-the-art diesel-electric interstate line-haul locomotives, such as Wabtec (former GE) Evolution ET44AC series (USA), and EMD SD70ACe-T4 series from Electro-Motive Diesel (USA). Competitively priced with Tier 4+ diesel-electric locomotives, with affordable off-grid renewable energy recharging infrastructure, absolute zero emission, improved productivity, and huge savings on fuel cost (5+ times), maintenance (2+ times), and cabin crew expenses (up to 2 times) make proposed Neon Zero locomotive natural choice for replacement of diesel-electric locomotives worldwide, and particularly in North America railroad freight service. The Neon Zero locomotives and nationwide recharging infrastructure will bring dramatic benefits to railroads, shippers and the public, more significant than switching from steam to diesel-electric locomotives. Enabling technology for practical battery-electric, long range line haul locomotive will be a new generation of low cost/high specific energy Lithium Nickel Manganese Cobalt batteries with high nickel/low cobalt content such as NMC 811, or similar chemistry. Such battery cells are coming into mass production around 2025, and soon will be available from all major battery manufacturers. First time in the history of electric vehicles, including locomotives, NMC 811 battery-powered vehicles will cost less than similar vehicles powered by diesel engines.

### CROSS-REFERENCE TO RELATED APPLICATIONS

This application claims the benefits of U.S. Provisional Patent Application Ser. No. 63/259,072 filed on Jun. 21, 2021, which is incorporated herein by reference.

### REFERENCES CITED

US PATENT DOCUMENTS

| | | | | | |
|---|---|---|---|---|---|
| 493,425 | March 1893 | Thomas A. Edison | 8,640,629 B2 | November 2010 | Barbee et al. |
| 1,424,848 | May 2017 | C. A. Pratt | 200702721 16 A1 | November 2011 | Bartley et al. |
| 1,535,175 | April 1924 | R. Mancha | 2008/0246338 | October 2008 | Donnelly at al. |
| 6,612,245 B2 | September 2003 | Kumar et al. | 7,661,370 B2 | February 2010 | Pike at al. |
| 2008/0270023 | October 2008 | Kumar | 20143023987 A1 | February 2013 | John Madsen |

### FIELD OF THE INVENTION

The resent invention relates to electric locomotives, particularly to long range, zero emission, battery-electric line haul freight locomotives, related off-grid renewable energy recharging infrastructure, and method of operation. This invention was privately funded. The government has no rights to this invention.

### BACKGROUND OF THE INVENTION

### US Freight Railroad Industry Overview

In the 18^{th} century the US economy was utterly dependent on water transportation. The cost of inland transportation was extremely high. To move freight 50 miles inland cost as much as to moving the same amount of cargo across the ocean. The industries and businesses, by necessity, were located near sea and river ports. Most of the US population lived within 50 miles of the Atlantic coast, and costal, rivers and Atlantic routes dominated goods and passengers movement.

Development of the steam locomotives and railroads from mid 19^{th} to the beginning of the 20th centuries allowed people to move inland from the east coast, and build cities and businesses close to major railroad routs and stations. East-West railroad routes were significant factor in the rapid growth of the United States and helped control huge West territories and resources. East-West railroad routs became dominant form of freight and passengers transportation until about 1956, when the US began construction of the interstate highway system, which was proclaimed complete in 1992.

The pick in the development of US railroads has been reached after World War 1 in 1917-1920. By that time it was 1,500 U.S. railroads operated about 254,000 miles of railways and employed 1.8 million people, more than any other industry. In 1887, the Interstate Commerce Act created the Interstate Commerce Commission (ICC) and made railroads the first U.S. industry subject to comprehensive federal economic regulation. Over time, excessive regulation would nearly destroy railroads. The Great Depression devastated railroads as well. Rail industry revenue fell by 50 percent, and about 30% of railroads went bankrupt. By the beginning of World War II, most railroads were in financial trouble.

After WW II decline continued. Railroads were losing huge amounts of money on passenger operations, but federal regulators often refused to allow railroads to discontinue money-losing passenger routes. The ICC set maximum and minimum rates for rail shipments, with rates often unrelated to costs or demand. In the early 1960s, for example, the ICC opposed the implementing of more productive new 100-ton hopper cars and use of the Unit Trains, highly efficient and less expensive way to move the freight. The ICC opposed, in part because the lower rates would take business away from more expensive waterways. Only after the U.S. Supreme Court decision in its favor railroads could introduce the new 100-ton cars. By the 1970s became clear that misguided railroad regulation was an important factor behind the railroad industry's decline. The ICC was terminated in 1995 and replaced with Surface Transportation Board (STB), an independent decision-making body.

After the passage of the Federal Highway Act of 1956, freight railroad system declined sharply, still the trucking industry expanded dramatically, and become major competitor of the freight railroad system. Now trucking industry did to railroads what railroads did to water transportation in the 19^{th} century: the eliminated necessity of businesses to be located near railroad hubs. Unlike railroads, 20 ton semi-trucks can deliver freight door-to-door even to most remote rural locations.

After years of revenue decline and bankruptcies of railroads, Federal Government enacted The Staggers Rail Act of 1980 which deregulated the US railroad industry. The Staggers Act followed the Railroad Revitalization and Regulatory Reform Act of 1976 (4R Act), which reduced federal regulation of railroads. The 4R Act reforms included an allowance of more options for pricing without close regulatory restraint, greater independence from collective rate-making procedures in railroad pricing and service offers, contract rates, and greater freedom for entry or exit from markets.

The Staggers and 4R acts have a dramatic effect on the railroad industry. The industry was consolidated into seven Class 1 railroads (companies with revenue >$500 mil/year) operating about 160,000 mi of tracks with combined revenue of more than $70 bil/year, or >93% of total freight railroads revenue. The remaining 7% of revenue is generated by ˜600 short-line and regional railroads, operating 44,000 mi of tracks. Seven Class 1 railroads are listed by revenue/market cap shown in FIG. 1A

From 1980 to 2018 Class 1 railroads reorganized operations by reducing tracks millage from 270,000 mi to 160,000 mi, the workforce from 458,000 to 147,000, increased traffic volume by about 2 times, and productivity (revenue ton-miles per employee) by more than 2.5 times, improved fuel efficiency more than 2 times, a reduced rate about 2 times, and increased return-on-investment from 4.2% to more than 11% among other achievements. Today the US rail freight system is competitive with the trucking industry, has a market share at about 28% of total domestic freight ton-miles originated in 2018, enough profit to operate and maintain existing infrastructure, as well as modest investment into capacity expansion, but not aggressive investment needed to keep pace with economic growth, and to maintain or increase market share.

In 2012 trucks moved about 72% of all freight tonnage/42% of all freight ton-miles, and railroads accounted for 11% of total freight tonnage, but 28% of total ton-miles. The trucks are particularly effective on routs shorter than 550 mi and longer than 2,250 mi. However, on the routs longer than 550 mi and shorter than 2,250 mi the railroads dominate the market, with market share >60% compare to trucks 31% of total ton-miles, which picking at about 1,350 mi long routs. As a result of constrained investment into infrastructure expansion, the US freight rail system market share is declining, which not in the public and shipper's best interest. The railroads move freight 2.5+ times cheaper than trucks ($0.04 per ton-mile for railroads vs. $0.11 for trucks), and have >4.5 times better fuel efficiency (480 revenue ton-mile/gal for railroads vs. 105 revenue ton-mile/gallon for trucks), consequently more than 4.5 times lower greenhouse gas emission.

Privately owned with no Federal Government subsidies, the US freight rail system is an extremely capital intensive business. It has to spend about 5 times more to maintain rail tracks and equipment than the average US industrial company spending on their infrastructure and equipment. To increase market share, railroads have to invest heavily, beyond what is available from today's revenues and borrowing, as well as rely on substantial public-sector participation. In this case railroads will capture a fair share of freight forecast growth, secure long-term revenue growth, and relieve anticipated congestion pressure on the interstate highway system. Another way to finance expansion is to drastically reduce the operating expenses, and generate substantially more net profit with the same or moderately increased freight volume. It can be done with battery-electric locomotives, off-grid renewable energy re-charging infrastructure, and an innovative operation method proposed in this patent.

### The Locomotives Overview

In the early stage of railroad construction the US used Great Britain's built steam locomotives. The first US made steam locomotive was introduced in 1831. Shortly, all steam locomotives for domestic use were built in the US by three major locomotive companies: Baldwin Locomotive Works, American Locomotive Company (ALCO), and Lima Locomotive Works. From 1831 to 1950 the US industry built 175,000 steam locomotives, 105,000 of which were made from 1901 to 1950 (an average of 2,100/year). The era of steam locomotives ended in mid 20^{th} century, when US Class 1 railroads decided to switch to diesel-electric locomotives.

ALCO and GE introduced the US first commercially successful small 300 Hp diesel-electric locomotive in 1925. It was used in switching and local freight and passenger services, and demonstrated that the diesel-electric locomotives could provide many of the benefits of electric locomotives without heavy investment in the railroads overhead electrification. Among such benefits were:

a) 5 times higher fuel efficiency (7% steam vs. 35% diesel-electric) and corresponding 2.5 times fuel cost savings (diesel fuel cost per BTU at that time was about 2 times more than coal);
b) substantial cost savings on the water and maintenance of water refilling stations. The steam locomotive used enormous amount of water from about 200 to 2000 gallons per mile and have a range of about 100-150 mi between water refilling;
c) substantial (3+ times) cost savings on train labors and locomotive maintenance;
d) ability of diesel-electric locomotive to be combined as remotely controlled multiple units (MU), which reduce the operating expenses and increase productivity by pulling longer and heavier trains by the crew in one cabin;
e) reducing emissions by 7 to 10 times;
f) increasing distance between refueling up to 1000 miles, saving time on refueling and increasing average speed;

The early diesel-electric locomotives, however, were small, expensive, and not reliable. In 1934 General Motor's Electro Motive Corporation (GM-EMC) developed model 201A 600 Hp diesel engine specifically designed for motive applications. Diesel-electric locomotives entered mainline service when the Burlington Railroad and Union Pacific made custom-built diesel-electric locomotives utilizing GM 201A diesel engine, for high speed streamlined passenger trains, named Zephyr. Zephyr's success encouraged GM-EMD to develop a dedicated 600 Hp to 2500 Hp locomotive engine (model 567), which was introduced in 1938, and the era of full scale dieselization began. It would be another 15 years before diesel-electric propulsion would show full potential to replace steam locomotives. In 1944 US railroads owned 40,000 steam locomotives. By 1960 only 260 steam locomotives left and 28,000 locos were diesel-electric. Full dieselization of US Railroads has been done in 15 years with an average replacement rate of about 1,800 Locos/Year.

After WWII GM-EMD dominated the market for mainline locomotives with their E and F series locomotives. ALCO-GE in the late 1940s produced switchers and road-switchers that were successful in the short-haul market. In 1949 EMD introduced GP series road-switcher locomotives, which displaced all other locomotives in the freight market. GE dissolved its partnership with ALCO and would emerge as EMD's main competitor in the early 1960s, later taking the top position in the locomotive market from EMD. Today GE (Now Wabtec) has a 70% market share vs. 30% of EMD. GE and EMD combined output for new locomotives are about 1000 to 1200 units/year. To meet the latest EPA mandatory emission standards, both companies introduced modern Tier-4 heavy haul locomotives in 2015. Specifications, description and images of GE Evolution ET44 locomotive can be found on manufacturer's websites.

The Tier-4 compliant line-haul locomotives will substantially reduce selected emission components compare to Tier-3 standards, which were in effect from 2012 to 2014, by following numbers: Nitrogen Oxides/NOx-4.23 times, Particulate Metter/PM-3.33 times, Hydrocarbon/HC-2.14 times, which is great. However, it will not reduce Carbon Dioxide/CO₂ and other Greenhouse Gases (GHG) emissions at all, as it was true with pre Tier-0, and all Tier-0 to Tier-3 locomotives, from the beginning of diesel-electric locomotives wide use. The CO₂ and another GHG emission can be reduced only by reducing (or eliminating) diesel fuel consumption. Unfortunately, total diesel fuel consumption, and CO₂ emissions, by US railroads remains constant at the level of about 3.6 billion gallons/year from 1960, the year of full dieselization, till today. US railroad system produces annually about 45,000,000 tons of CO₂ and other GHG. To put it into perspective, in 60 years after full dieselization of US Railroads, diesel-electric locomotives made enough CO₂ and another GHG to cover the entire continental USA with a layer of 60 foot thick, and the process is still going on.

When EPA increases mandatory emission standards, the public is benefits from lower emissions. However, with current policy, privately owned US railroad system has to pay a hefty price for such public benefits. Each new higher Tier locomotive historically cost railroads an extra $500,000, or about $10 billion system-wide in 20 years. It is an incremental cost, in addition to what railroads have to spend to replace aging locomotives. From a financial stand point of view ever increasing Tier system is not Class 1 railroad's best friend. The EPA Tier system is not sustainable, unless the current policy will be changed, and public will pay for the environmental benefits via emission reduction credit, or a similar Federal Government mechanism. Another way to go is to eliminate use of diesel fuel at all, by replacing diesel locomotives by the battery-electric, off-grid renewable energy infrastructure, and innovative operation method proposed in this patent.

### US Freight Trains

To move different commodities, the railroads form trains utilizing different type of cars and locomotives. In 2018 the average system-wide US freight train had 73.2 cars (69.1 East/77.4 West), carry 3,640 Revenue-Tone, had about 6,750 Gross Ton Weight, an average haul length of 1,033 mi, and average speed of 25.4 mph. The numbers of locomotives used to move trains depends of the train gross weight, speed, and route's maximum grade, among other things. A typical power load of US freight trains varies from 0.75 to 2.5 combined Horse Power of locomotives divided by Gross Ton Weight of the train (HP/GTW). The lower end of the power load (0.75-1.0) is used for the slower-moving trains (15 mph-20 mph) on modest grade routes, like 16,500 GTW coal or grain unit trains moving with 20 mph speed in the Central US. Typically, 3×4400 Hp locomotives will power such trains, with a power load of 0.8. Higher-end of the power load (2.0-2.5) is used for faster (30-40 mph) moving freight trains, like 8,000 GTW intermodal double-stack container trains on BNSF Southern Trans Con route from Los Angeles to Chicago with some very steep mounting passes. Typically, 4×4400 Hp locomotives will power such trains, with a power load of 2.2. The average US freight train described above will be powered by 2×4400 Hp locomotives with a power load of 1.2 hp. FIG. 6, FIG. 7, FIG. 8, FIG. 9 show typical US freight trains.

### The Diesel-Electric Locomotives and Freight Trains Fuel Efficiency

The fuel efficiency of freight trains with any given locomotives will depends greatly of several major factors such as gross train weight, train speed, vertical profile (grade) of the train route, frequency of train stops, and length of the train route. Other factors such as weather, tracks condition, temperature, elevation e.t.c will also affect fuel efficiency. The railroads measures train efficiency by numbers of Revenue Ton-Miles (RTM) train can carry on 1 gallon of fuel (RTM/Gallon), or by numbers of Gross Ton-Miles (GTM) train can pull on 1 gallon of fuel (GTM/Gallon).

In 2017 the average US system-wide fuel efficiency of the freight trains was 479 RTM/Gal (˜890 GTM/Gal), compare to 396 RTM/Gal in 2000, or a 21% increase in 17 years (1.23%/year). The fuel efficiency of the freight trains is much higher than fuel efficiency of semi-trucks, with an average fuel efficiency of about 100-110 RTM/Ga. Even with fuel efficiency improvement over the years, total fuel consumption remains virtually the same over the last several decades because of an increased volume of freight movement. US Freight system use about 3,600 billion gallons of diesel fuel annually, which cost on average $2.83/Gallon in 2020 dollars, or over $10 billion/year. The fuel expenses account for 15% to 25% of Class 1 railroad's total operating expenses. FIG. 2C compares the fuel efficiency of battery-electric to diesel-electric locomotives. FIG. 10 shows the fuel efficiency of US freight trains on actual routes.

### Electrification of US Freight Railroads and Electric Locomotives

Electric locomotives have about 2.6+ times higher fuel efficiency (85% vs. 33%), and can additionally recover up to 20% of energy via regenerative brakes, which make them attractive alternative to replace diesel locomotives. However, they need an electric power source on board or overhead power lines to feed electric traction motors. Tomas Edison patented the first electric locomotive and railroad electrification in 1893. Soon Edison realized that such a system would be prohibitively expensive and abounded the idea. It remains true even today, especially for US privately owned freight railroad system with long intercontinental routes and heavy trains. Some countries in Europe and Asia, where railroads owned or highly subsidized by Governments, electrified railroads a long time ago, mainly for passenger operations.

The US has several relatively short electrified routes for passengers operation as well as 3 very short freight routes less than 100 miles long. According to some experts electrification of 94,000 miles of US Freight Railroad system will cost same or more as to build entire railroad system from scratch again, or about $5 to $10 trillion dollars ($50 to $100 million/mi), which can't be done by privately owned railroads even with US Government generous subsidies. It seems that the $50-$100 millions/mi cost estimate may be on the lower end, especially if count cost of needed ˜100 GW of new power plants, and ˜10,000 mi of new transmission lines. For example, the proposed 500 mi long electrified high-speed passenger route between Los Angeles and San Francisco has a price tag of about $200 millions/mile in 2019 dollars.

### Battery-Electric Locomotives and Recharging Infrastructure

Today only viable alternative to diesel-electric locomotives or electric locomotives with overhead or 3d rail power lines will be battery-powered electric locomotives with off-grid renewable energy recharging infrastructure. Even 5 years ago such locomotives and recharging infrastructure were unthinkable, because of lack of low cost, high specific energy, high power, and sufficiently long life cycles batteries, and high cost of renewable energy. Resent changes in battery technology and substantial price drop make long range, heavy haul battery-electric locomotives proposed in this patent reality in the next 5 years. Another recent phenomenon was the drastic cost reduction of solar PV and Wind power plants. Today cost of electricity from land based Wind and Solar PV power plants become lowest among new power plants. Off-grid, renewable energy power plants distributed along railroad routs are the only practical solution to US railroads electrification.

### Electricity vs. Diesel Fuel

One Gallon of diesel fuel equivalent to 40.65 kwh of electricity, or in other words 40.65 kwh of electricity=1 Gallon Diesel Fuel Equivalent (GDFE). As shown in FIG. 10 BNSF 8,100GT Intermodal Train powered by 4×4380 HP locomotives on South Trans Con Rout from Los Angeles to Chicago consume 28,675 gallons of diesel fuel, and has fuel efficiency of 430 RTM/631 GTM per Gallon. The same train on the same route powered by 4× Neon Zero 16 MWH/4500 HP locomotives will consume 376 Mwh of electricity or 9,250 Gallon Diesel Fuel Equivalent, and have a fuel efficiency of 1,333 RTM/1,956 GTM per Gallon of Diesel Fuel Equivalent or about 170 kwh/mile.

According to Union Pacific statistic 10 years (2008-2017) average diesel fuel cost for Class 1. Railroads was $2.486/gal in the actual dollars, or $2.83/gal adjusted to the 2020 year (See Table 3). In 2021 US average rate for industrial electricity was $70.1/Mwh ($0.0701/kwh), as shown in FIG. 17, which is $2.84/Gallon Diesel Fuel Equivalent, or about the same average price of discounted Class 1 railroad's diesel fuel. However, Class 1 railroads are very large wholesale customers for fuel suppliers and typically get >20% discount. Assuming same 20% discount on electricity, Industrial Electricity Rate from the Grid for Class 1 Railroads may be 457/Mwh ($0.057/Kwh) or $23 per Gallon Diesel Fuel Equivalent, vs. average diesel fuel cost of $2.84/gal, or about 1.23 time lower. If proposed renewable, off-grid recharging infrastructure will be used, instead of public grid, fuel cost may be as low as $1.2 per GDFE. See paragraph [028].

Another disadvantage of diesel fuel is its highly volatile price. It may go up and down at any moment as much as 2 times or even more. As an example, FIG. 3C shows the price of diesel fuel from 2008 to 2017 compiled from Union Pacific SEC annual reports. To soften the fuel volatility's effect on financial results of railroads operations, all Class-1 railroads use fuel surcharges, often very hefty, sometimes as much as 50-80% of total fuel cost. The railroads have the legal right to impose any surcharges on unregulated tariffs, or use any tariffs structure as they deem appropriate. Yet, applying fuel surcharges make customers/shippers unhappy, and they may switch service to other mode of transportation if they can. If not, they usually express their frustration by filling massive lawsuits. For example, from 2007 until today major Class-1 railroads fighting class action lawsuit related to fuel surcharges from ˜30 unhappy shippers. And even if it is legal, it cost money to fight such lawsuits, and will create unhappy customers if they lose the case, which is not in railroad's best interest

Neon Zero re-charging infrastructure, however, will not use National Grid, as a prime source of electricity to recharge the locomotive's batteries, for several reasons, namely:

a. lack of sufficient power in National Grid. 350×250 MW new gas power plants will be needed to power chargers on 94,000 miles of railroads, and ˜$175 billion to build them;
b. lack of power grid in places close to re-charging stations along freight railroad routs, many of which are crossing sparse populated areas, will require ˜10,000 miles of new transmission lines worth of ˜$300-$500 billion, and 15-20 years of approval process to start building them;
c. 350 natural gas power plants dispersed along 94,000 miles will need ˜100,000 miles of gas pipelines to deliver gas to power plants, $350 billion to build them, and >15 years to get approvals;
d. cost of electricity from new natural gas power plants built in sparse populated areas will be too expensive;
e. luck of US tax incentives for air-polluting power plants;

Neon Zero re-charging infrastructure will use Dedicated, Off-Grid (not Connected to the Grid), solar PV panels, or Wind Turbines power plants, combination of both, or other renewable energy sources located in near proximity (1-10 miles) to the re-charging stations, with no fuel delivery logistic, and virtually no transmission lines. Even today, such re-charging infrastructure will provide the cheapest possible electricity, with unsubsidized cost below $47/Mwh ($0.047/Kwh), or about $1.91 per Gallon of diesel fuel equivalent (GDFE). It is >1.5 times cheaper than the average diesel fuel cost. At the foreseeable future, electricity from Solar and Wind power plants will continue downward trend. It will reach the cost of about $30-$35/Mwh in 2025, or $1.2 to $1.4 per GDFE. It is >2 times cheaper than the average diesel fuel cost.

Neon Zero recharging infrastructure may also purchase electricity from renewable energy sources on the wholesale market, especially in densely populated metropolitan areas with inadequate solar or wind resources. If available, such electricity can be purchased at close to zero, at zero or even a negative price. Zero price means that electricity for the buyers will cost exactly $0/kwh, and negative price means that renewable electricity power plants will pay railroads a specified amount of money (often $20/Mwh) to use their renewable electricity. Such, seams unusual, deals are available for renewable energy, especially Solar and Wind power plants with battery storage capability, in regions where Production Tax Credit or Feed-in-Tariffs, and Renewable Portfolio Standards are in effect. Zero or negative prices are not available for diesel fuel.

Now we'll go back to the example in paragraph [024]. BNSF will have ˜6.1 times lower fuel cost, moving Intermodal Train on Southern Trans Con Rout by Neon Zero locomotives, compare to the state-of-the-art diesel-electric locomotives. The savings will be: Diesel-Electric locomotives fuel cost is 28,675 gal×$2.83/gal=$81,150/trip, Neon Zero Electricity cost is 376 Mwh×$35/Mwh=$13,160/trip, or savings of $81,150-$13,160=$67,990 per one way trip from Los Angeles to Chicago. BNSF runs up to 100 trains/day on this route, so BNSF fuel cost saving may be >$600 mil/year on Southern Trans Con Rout alone.

The electricity from Neon Zero off-grid re-charging infrastructure powered by renewable energy sources, not only costs substantially less than diesel fuel, but it also has long-term fixed price, guaranteed by 20-25 years Power Purchase Agreements (PPA). Today, in anticipation of further drops in electricity cost from new Solar and Wind power plants, most PPAs don't have even inflation riders, which actually make the cost of electricity lower every year. Fixed price of electricity will make fuel surcharges unnecessary, still, even if railroads choose to impose 100% fuel surcharges, it will not make unhappy customers, because overall tariffs may go down, if railroads choose to do so. With Neon Zero locomotives, railroads can afford to drop tariffs, invest more in infrastructure capacity, and go after trucking industry market share.

From an economic and environmental standpoint, electricity from Neon Zero re-charging infrastructure is far superior to diesel and other carbon fuels, and it is 100% Zero emission system. It will eliminate all kinds of emission, particularly Green House Gases/CO₂, level of which remains virtually unchanged since 1960, year of full dieselization of US Freight railroads. Replacing 25,000 diesel-electric locos by Neon Zero locomotives will eliminate system-wide about 50,000,000 ton/year of CO₂ and other GHG, which can be monetize by railroads similarly to sequestration of the GHG/CO₂ by coal/gas power plants via Federal Tax Credit at about $25-$50/Ton. Such Tax Credit alone can give US Freight Railroads additional money to offset cost of battery-electric locomotives to the point when Neon Zero locomotives will cost same or less than state-of-the-art diesel-electric locomotives.

### Locomotive Maintenance: Neon Zero vs. Diesel-Electric Locomotives

Another advantage of Neon Zero locomotives compare to diesel-electric locomotives, particularly to Tier 4+ locomotive with complex and high maintenance after-treatment system, is lower maintenance cost. According to Norfolk Southern (NS) in 2010 diesel-electric locomotive annual maintenance cost for 5 Class-1 railroads ranged from $124,720 to $203,840. Norfolk Southern data are shown in FIG. 4D in actual 2010 dollars, and adjusted to inflation in 2020 $$.

(Previously Presented) Data on maintenance cost of line haul battery-electric locomotives is not available at the present time, however an estimate can be made using data on electric locomotives with a catenary overhead power line. Siemens, the manufacturer of electric locomotives recently offered a comparison of lifetime maintenance costs for 8,500 HP electric and 3,000 HP diesel-electric locomotives based on 150,000 km (˜93,000 mi) annual utilization. The comparison shows that electric locomotive has 69% lower lifetime maintenance cost compare to diesel-electric locomotives.

In 1976 study of locomotives maintenance cost have been conducted by the Electro-Motive Division of General Motors and published by Max Ephraim. In the EMD study, the maintenance cost of 3000 HP diesel-electric loco in heavy-duty freight service was $40,028 (in 1975 $). Adjusted to 2020$, it is equal to $197,530, very close to our data in FIG. 4D. EMD compares it to a 6000 HP electric locomotive with an overhead power supply. The cost was $26,000 (in 1975 $$) or $122,200 in 2020$$. Electric loco in EMD example has a big difference in locos horse power, extra equipment like a pantograph, circuit breaker, and transformer, which account for ˜13% of the maintenance cost. Assuming that difference in horse power will reduce Neon Zero maintenance cost by an additional 20%, the EMD cost estimate will be reduced by 33% to $122,200×0.66=$80,652 in 2020$, or 2.45 times lower than the maintenance cost of a diesel-electric locomotive.

In 1976, a locomotive maintenance cost study was conducted by British locomotive manufacturer Brush Electrical Machines Ltd and published by Graham S. W. Calder. Calder compares numbers of annual maintenance man-hours needed for diesel-electric and electric locomotives. According to Calder, electric locomotives require 500 man-hours of maintenance vs. 1240 man-hours for diesel-electric, or about 2.25 times lower. The Calder numbers very close corresponds to adjusted maintenance cost estimate made by EMD. For Neon Zero maintenance cost difference of 2.4 times, or $80,000/Year in 2020 Dollars will be used. Saving on annual maintenance cost will be >$100,000 per Neon Zero locomotive. Replacing 25,000 diesel-electric locomotives by Neon Zero will save US Railroads $2.5 Billion/Year, or $50 Billion over 20 years locomotive life span. FIG. 5C shows Calder's annual man-hours spent on locomotives maintenance.

### SUMMARY OF THE INVENTION

The Neon Zero locomotives are designed to exceed the performance and operational capabilities of current state-of-the-art diesel-electric line haul locomotives, such as Wabtec Corp (former GE) Evolution ET44AC, and EMD SD70ACe-T4 series locomotives. Competitively priced with Tier 4+ diesel-electric locomotives, powered by affordable off-grid renewable energy recharging infrastructure, absolute zero emission, improved productivity, and huge savings on fuel cost (5+ times), maintenance (2+ times), cabin crew expenses (up to 2 times), and possible several US tax incentives, make Neon Zero locomotives a natural choice for replacement of all diesel-electric locomotives. Neon Zero locomotives will bring dramatic benefits to the public, shippers and railroads, far greater than switching from steam to diesel-electric locomotives.

### Neon Zero 4500e Interstate Line Haul Locomotive

The Neon Zero locomotives come in two basic versions: the main locomotive with a crew cab (FIG. 2A), and the remotely controlled (RC) version (FIG. 2B), operated from the leading locomotive, when they work as multiple units (MU) in heavy train consists. The Neon Zero 4500e locomotive is powered by 6 AC traction motors with a combined power of 4500 Hp. The batteries of both Main and RC locomotives have a generous capacity of 16 MWH (Main) and 22 MWH (RC) per loco. The batteries sized to move fast, 8000+ Gross Ton, 85 Cars, double stack, Intermodal container train by 4×4500e Neon Zero locomotives 410+ miles on the single battery charge, or about 12+ hours of non-stop driving at 34 MPH average speed. The average US system-wide freight train (74.3 cars, 3 locos, 6750 GTW, 1,033 mi average haul, 25.4 average speed) will have maximum range on a single battery charge of 600+ miles, or about 24 Hrs of non-stop driving. 4× Neon Zero 4500e locomotives capable of moving 8000+ Gross Ton Intermodal Double-Stack Train on BNSF Southern Trans Con rout from Los Angeles to Chicago (2,230 miles) with 8×30-45 minutes recharging stops. No Battery Tenders are needed to move typical trains from cost-to-cost with the proposed recharging infrastructure. FIG. 2A and FIG. 2B show Neon Zero 4500e Main and Neon Zero 4500e RC locomotives. FIG. 4A shows Neon Zero 4500e Main Locomotive cut-out.

### Neon Zero 6000e High Productivity Line Haul Locomotive

The Neon Zero 6000e locomotive represents the next level of productivity for railroads freight movement. They have increased battery capacity to 20 MWH for Main (FIG. 3A and FIG. 5A) and 28 MWH for RC (FIG. 3B and FIG. 5B) locomotives, 6 powerful AC traction motors with the combined power of 6,000 HP, and increased an average tractive force. Such locomotives capable to move longer and heavier next generation typical trains, for example 8000 Ft long/10,500 GTW, 150 Cars Intermodal Double-Stack Trains, or 8,000 Ft/21,500 GTW, 150 Cars Coal/Grain Unit Trains, with 4×6,000 HP MU locos per train consist, vs. 5 diesel-electric locos, which equals to ˜30% increase in productivity. Also, Neon Zero 6000e can move today's typical trains with reduced by one number of MU locos needed per train (3 Neon vs. 4 Diesel, or 2 Neon vs. 3 Diesel), which corresponds to a 33% to 50% increase in productivity. The Neon Zero 6000e locomotives use the same recharging infrastructure as Neon Zero 4500e with 30-45 minutes recharging time, and 24/7 power availability. No Battery Tenders will be needed to move super heavy trains from cost-to-cost with the proposed re-charging infrastructure.

Network of Off-Grid Chargers powered by dedicated renewable power plants located close (1-10 miles) to chargers and spaced along the routes on average 300 miles. Such average distance, at 25 mph average train speed, will coincide with train crew change, which has a mandatory maximum on-duty time of 12 hours, and routine train inspections. The recharging time of the batteries is 30 to 45 minutes, same as time needed to change the cab crew and conduct routine train inspection. Off-grid solar PV or Wind turbine power plants have battery storage to provide 24/7 power availability.

Design and architecture of battery-electric line-haul locomotives not so different from the diesel-electric locos. In fact, the diesel-electric locomotives are half-electric already. Battery-electric locomotives designed to same Plate L specification, have same Gross Vehicle Weight, locomotive platform, crew cabin, bogies, traction motors, brakes, electrical equipment, control system e.t.c. The difference is in the prime mover and related equipment. Diesel-electric locomotives use diesel engines as a prime mover, and battery-electric locos are powered by a rechargeable battery, which have to be recharged. To simplify comparison, we may say that battery-electric line-haul locomotive is a diesel-electric locomotive with replaced, by battery, diesel motor and related equipment such as: main and auxiliary alternators, dynamic brakes resistor's grid, radiator and radiator fan, fuel tank, engine muffler, engine water tank, lube oil tank e.t.c.

The design of diesel-electric, hybrid and battery-electric locomotives is well known and widely presented in prior art literatures and multiple patents. For example, readers may use General Electric Transportation (now Wabtec) illustrated manual for latest diesel-electric locomotives ES44 Evolution series. The manual available for download on company website, and in great details describes modern diesel-electric locomotive and all locomotive's sub-systems. In Railway Technical publications, available at www.railway-technical.com, readers may check the following articles on the subject: “Electric Traction Power Supply” copyright 2000, or “Diesel Locomotive Technology” copyright 2000, 2001.

Several patents described various aspects of diesel, hybrid and battery-electric locomotives. For example, US patent 2010/0275810 A1 by Barbee et al. presented all battery-electric short-range/switch yard locomotive designs. However, described locomotive design, cannot be scaled up to long range, line-haul locomotive, nor teach us how to do that.

US patent 2001 6,308,639 B1 by Donnelly et al. described hybrid battery/gas turbine locomotive, and in US patent 2008/0246338 A1 by Donnelly et al. described multi-power locomotive and control method and system. US Patent 2003 6,612,245B2 by Kumar at al. described hybrid energy locomotive system.

US patent 2010/7,661,370 B2 by Pike et al. is teaching how to build large battery packs for hybrid locomotives, design ventilation systems, provide vibration and shock resistance of battery cells, and structural integrity of the battery during the derailment. US patent 20140239879A1 by John Madsen presented a battery charging system for locomotives.

Each of these literature and patents described above is hereby incorporated into the present application in their entirety. This application is focused primarily on the novel, long range line-haul battery-electric locomotive, and particularly on high capacity locomotive's battery, and off-grid renewable energy recharging infrastructure, both are the “Achilles Heels” for such project, so design details of the locomotive itself doesn't have to be provided in more details than necessary to understand the scope of the invention.

### BRIEF DESCRIPTION OF THE FIGURES

FIG. 1 shows Neon Zero 4500e Main battery-electric locomotive.

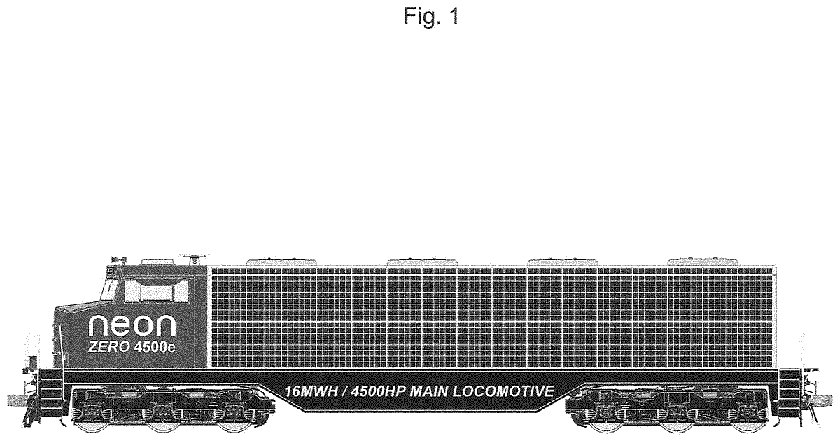

FIG. 1A shows Seven Class 1 Railroads by revenue and market capitalization.

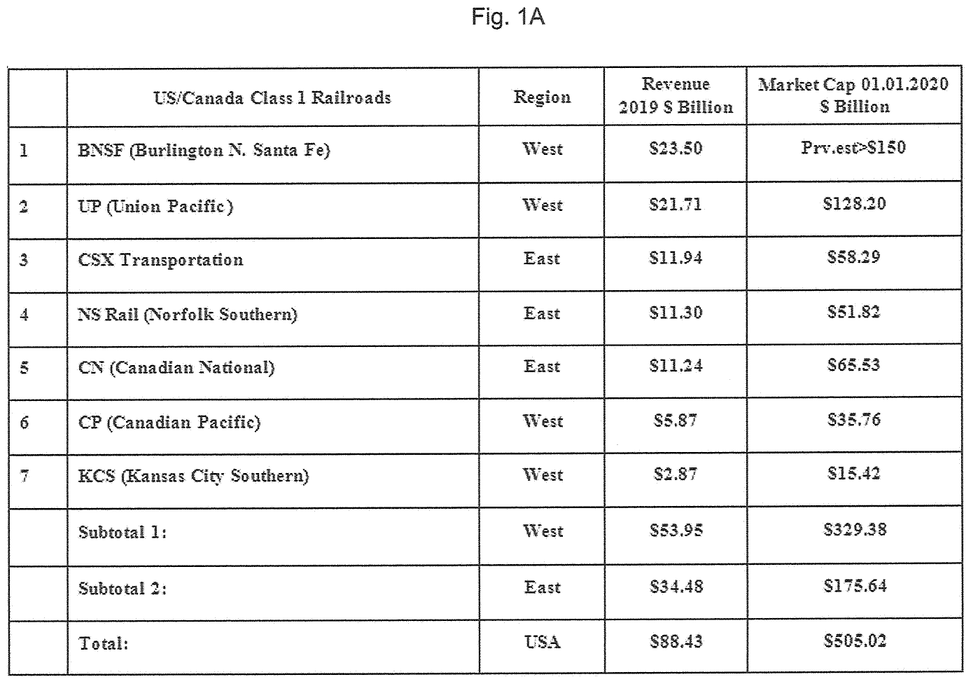

FIG. 2A shows Neon Zero 4500e Main battery-electric locomotive.

FIG. 2B shows Neon Zero 4500e Remotely Controlled (RC) battery-electric locomotive.

FIG. 2C shows the fuel efficiency of battery-electric vs. diesel locomotives.

FIG. 3A shows Neon Zero 6000e Main battery-electric locomotive.

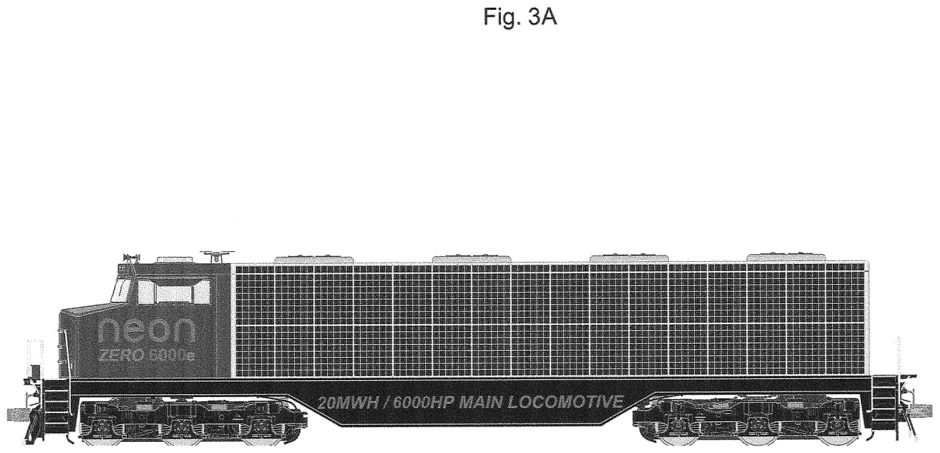

FIG. 3B shows Neon Zero 6000e Remotely Controlled (RC) battery-electric locomotive.

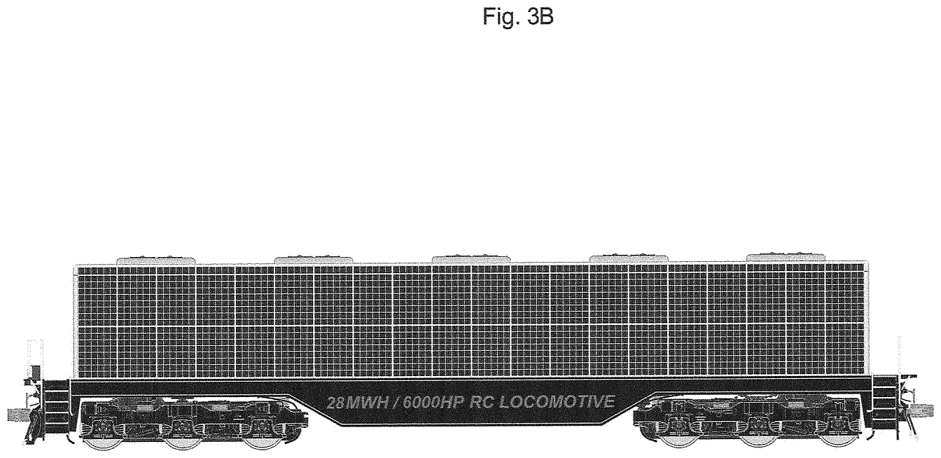

FIG. 3C shows historic diesel fuel price for Class 1 railroads from 2008 to 2017.

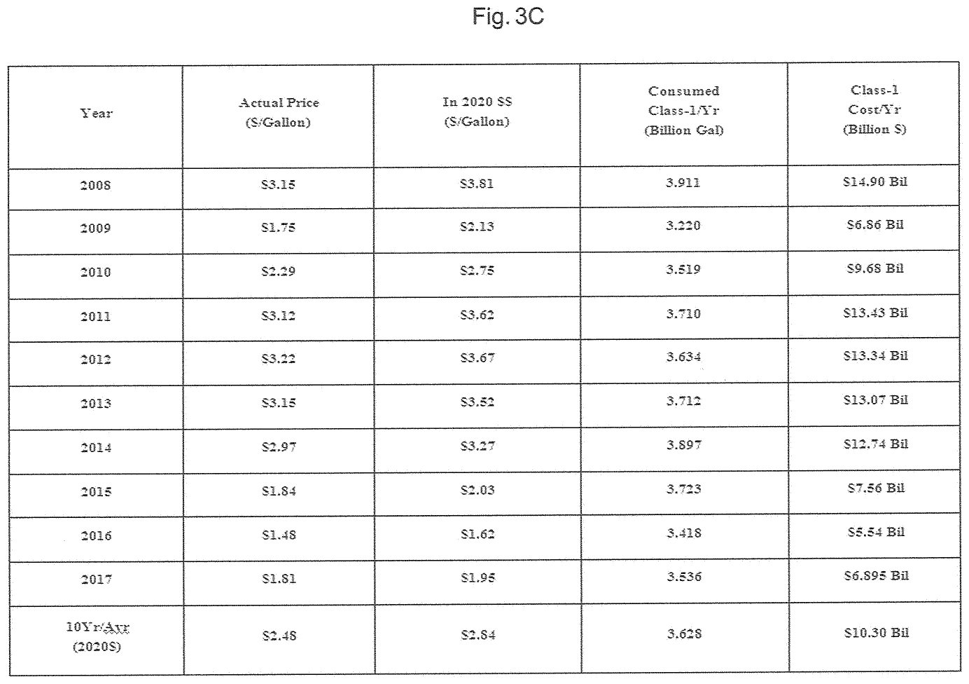

FIG. 4A shows Neon Zero 4500e Main battery-electric locomotive cut-out.

FIG. 4B shows Neon Zero 4500e battery cut-out side view.

FIG. 4C shows Neon Zero 4500e Main battery module cut-out top view.

FIG. 4D shows Class 1 Railroad's diesel locomotive annual maintenance cost.

FIG. 5A shows Neon Zero 6000e Main battery-electric locomotive cut-out.

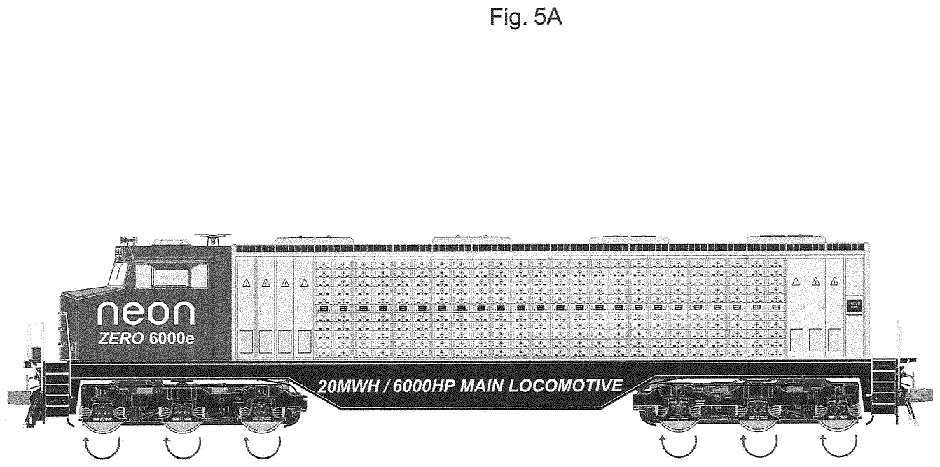

FIG. 5B shows Neon Zero 6000e Remotely Controlled (RC) battery-electric locomotive cut-out.

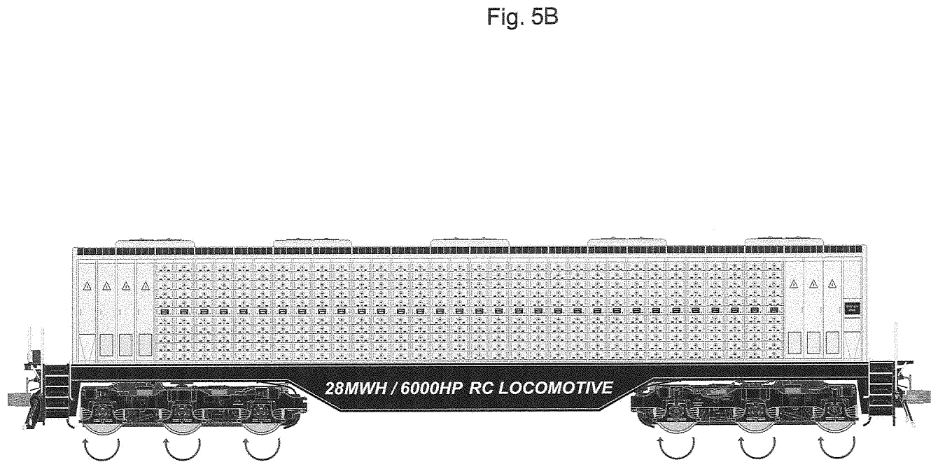

FIG. 5C shows maintenance annual man-hours needed for diesel vs. electric locomotive.

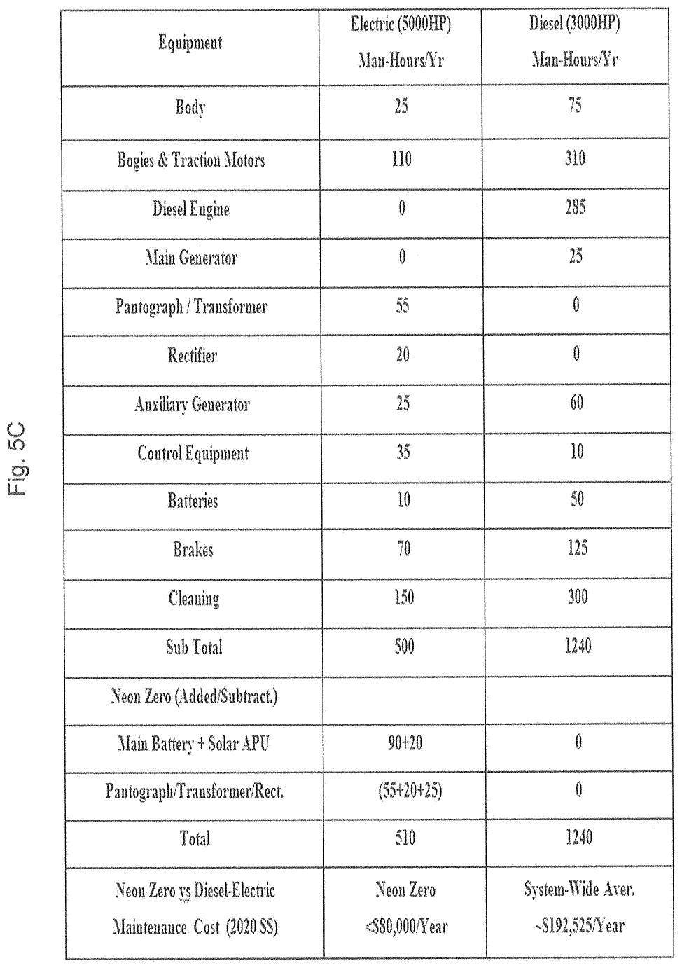

FIG. 6 shows BNSF intermodal double-stack container train.

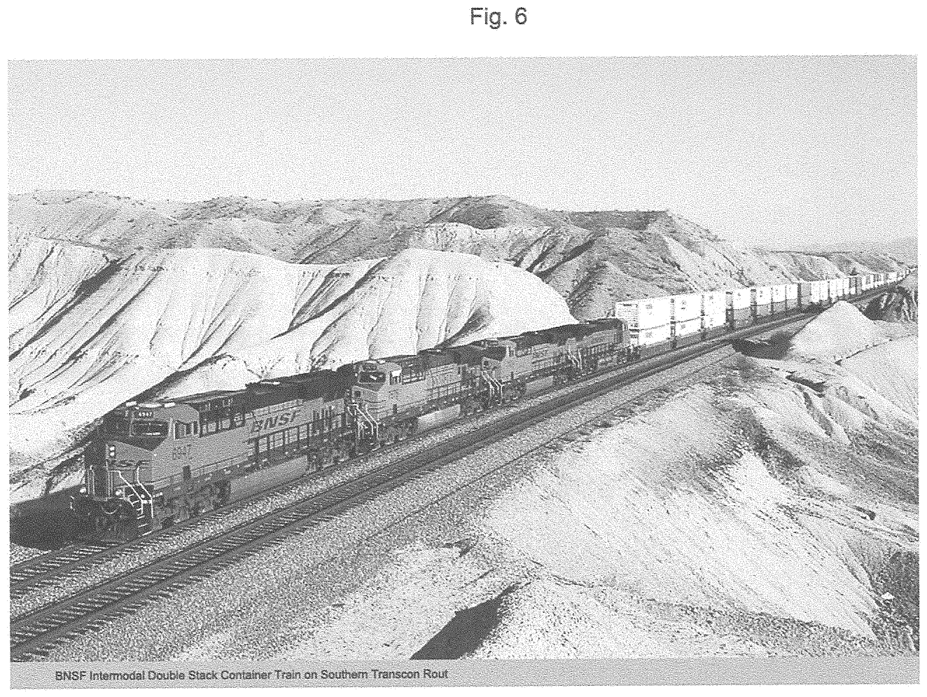

FIG. 7 shows the Southern Pacific coal unit train.

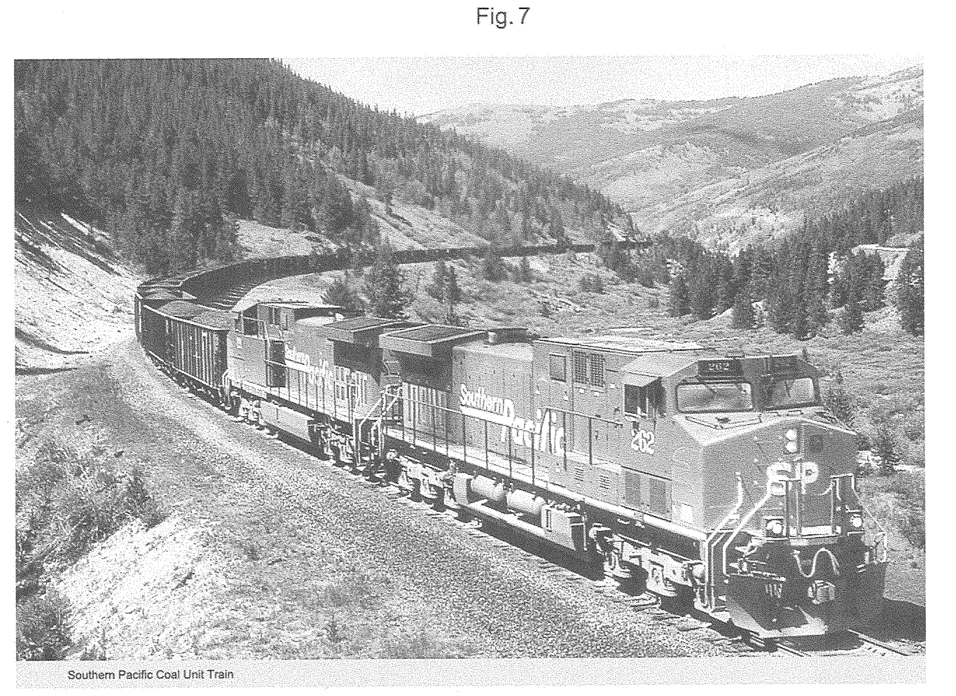

FIG. 8 shows the BNSF grain unit train.

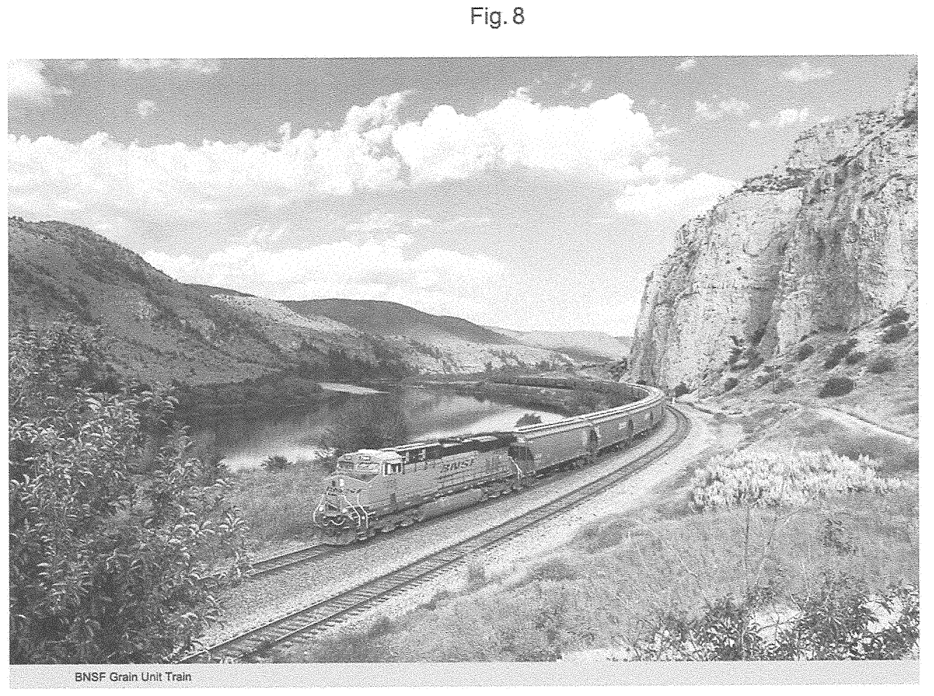

FIG. 9 shows the BNSF Auto Unit train.

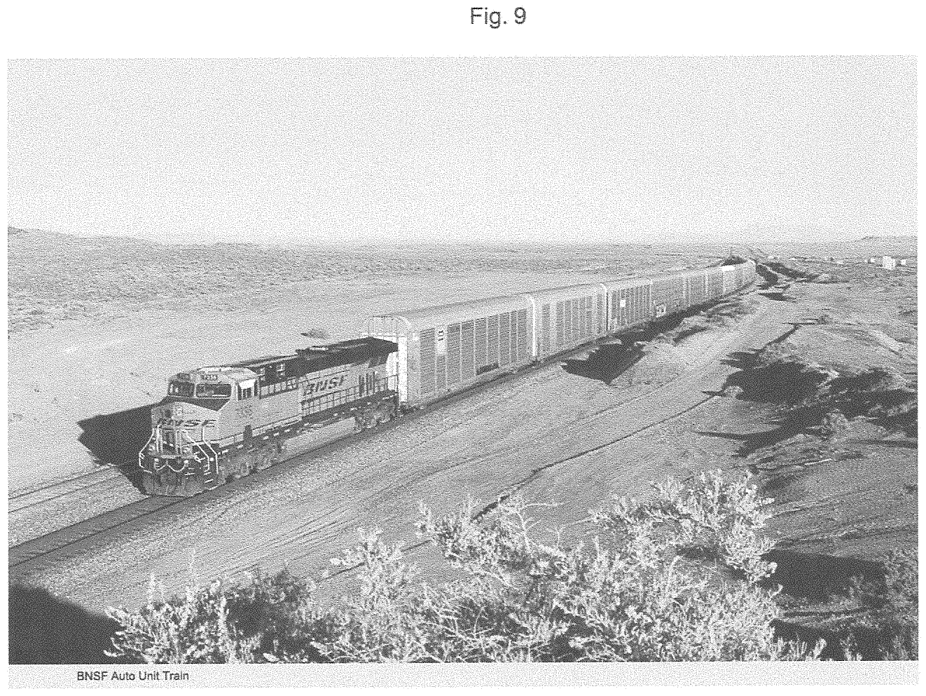

FIG. 10 shows the fuel efficiency of typical trains on actual selected routs.

FIG. 11 shows Neon NMC 622 battery cell specification.

FIG. 12 shows Neon NMC 811 battery cell specification.

FIG. 13 shows life cycles graphs of the Neon NMC 622 battery cell.

FIG. 14 shows the map of US primary freight railroad corridors.

FIG. 15 shows map of US solar resources with BNSF intermodal network.

FIG. 16 shows map of US wind resources with BNSF intermodal network.

FIG. 17 shows a US map of industrial electricity rates by states.

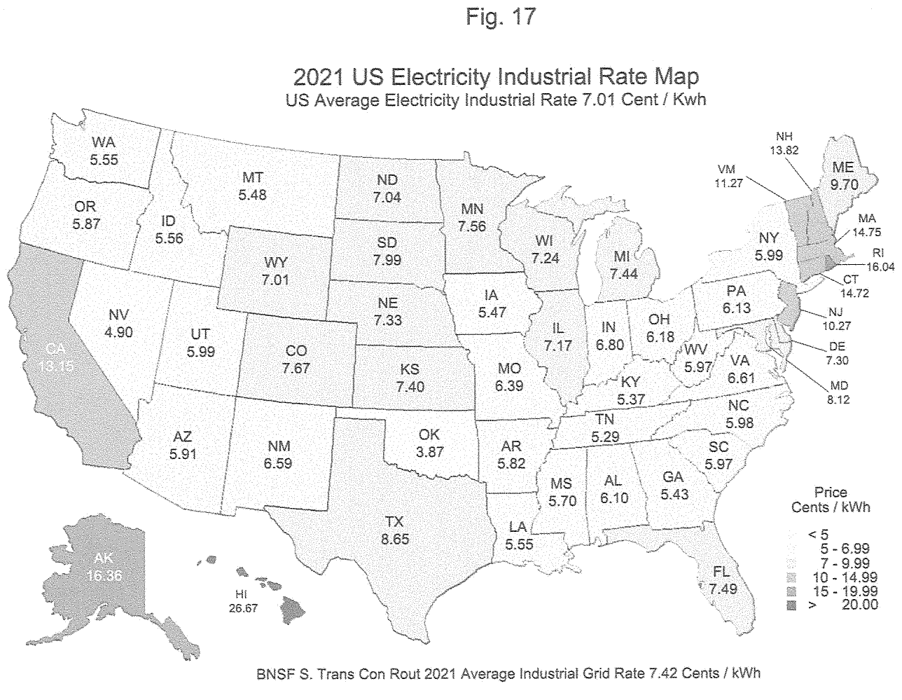

FIG. 18 shows Neon Zero battery module drawings.

FIG. 19 shows Neon Zero battery enclosure cross-section front view drawings.

FIG. 20 shows Neon Zero battery enclosure cross-section side view drawings.

FIG. 21 shows Neon Zero battery enclosure cross-section top view drawings.

### DETAILED DESCRIPTION OF THE INVENTION

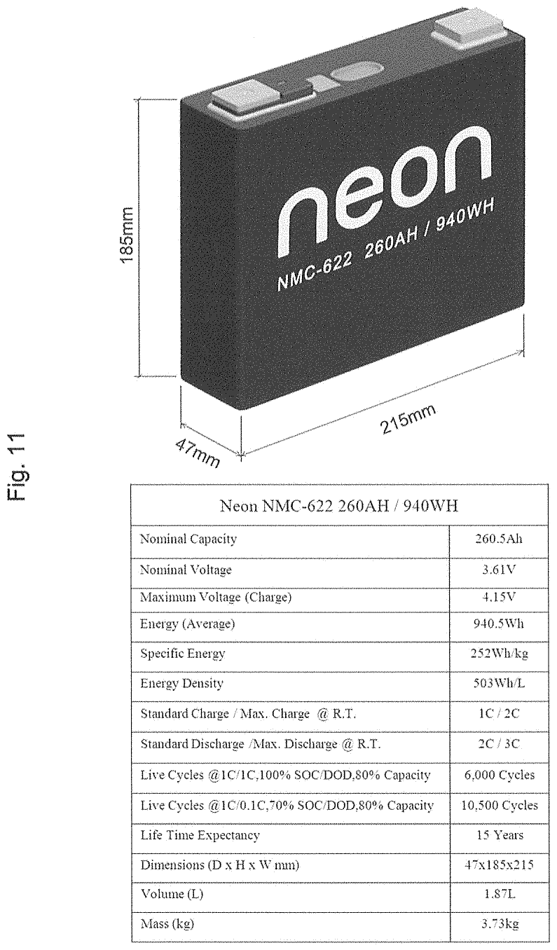

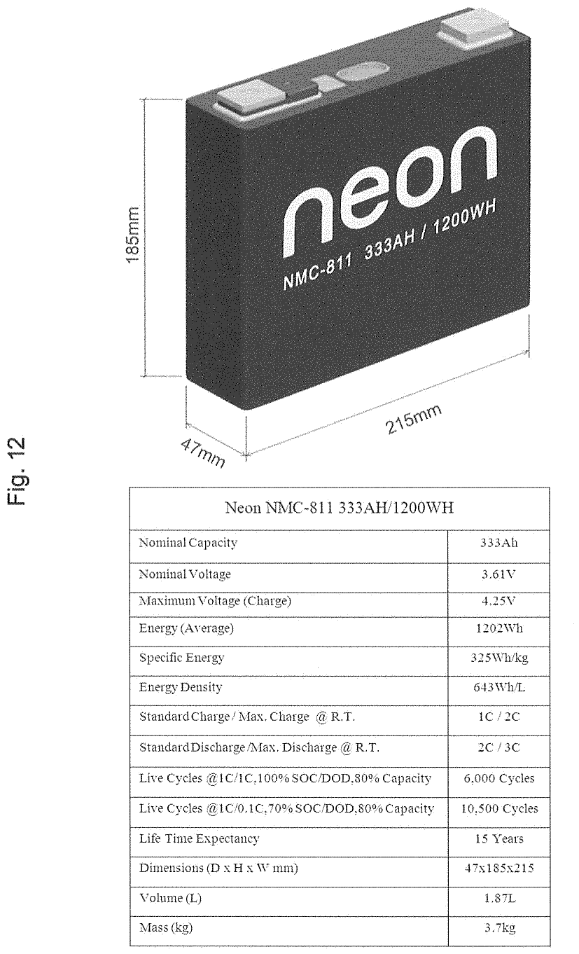

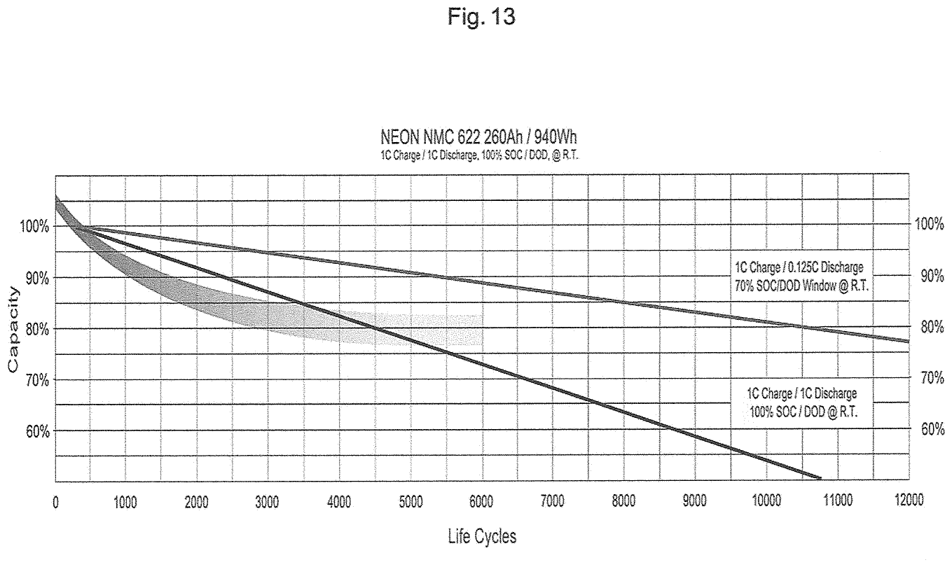

The Neon Zero locomotives, presented in this invention, become possible only because of recent development of low cost, high specific energy, fast recharging time, and high life cycle Lithium Nickel Manganese Cobalt battery cells with high nickel/low cobalt content (NMC 811, NMC 622 or similar chemistry). Such battery cells soon will be available from all battery manufacturers. NMC 622 is a more mature technology, and will come on the market first, and NMC 811 will follow after. The first time in the history of electric vehicles, including locomotives, NMC 811 battery powered vehicles will cost less than similar vehicles powered by internal, combustion (including diesel) engines. Neon NMC 622 and NMS 811 battery cell drawings, specifications and life cycle graphs are presented in FIG. 11, FIG. 12 and FIG. 13.

### Neon Zero Locomotive Battery Sizing

The Neon Zero battery size depends on several major factors such as: available volume and maximum weight locomotives have for the battery, volumetric and gravimetric specific energy of the battery cells high enough to fit in the available volume and available weight limit, energy consumption for particular trains on particular routes, average and maximum distance between recharging stations, and battery cost consideration. The locomotive battery has to be sized to move, with reasonable reserve, less energy-efficient trains, a.k.a heavy and fast trains on the route with steep grades. From an operational stand point of view, Neon Zero chargers spaced on average at 275+/−miles, and a reserve set up for at least 50+ miles, or about 2+ hours drive time before recharging. Because of limitations on available space and weight, Neon Zero locomotive can accommodate battery weight of <105 metric ton, and 48 or 64 (Main/RC Loco) 19″ battery racks.

The battery capacity for Neon Zero 4500e locomotives sized at 16 Mwh for Main and 22 Mwh for RC locomotives. Such numbers arrived from energy consumption of 6,500 Ft long/8,100 Ton Gross Weight fast, Intermodal Double-Stack trains on steep grades routs, such as BNSF Southern Trans Con and UP Sunset Routs. The trains are maxed-out by weight for 6,000+ Ft long typical sidings, and have lower fuel efficiency compared to the average US system-wide train. 4× Neon Zero 4500e locomotives (2 Main+2 RC) will need total of 73 Mwh of electricity to move such trains 275 miles with 50+ miles/2+ Hours distance and other reserves.

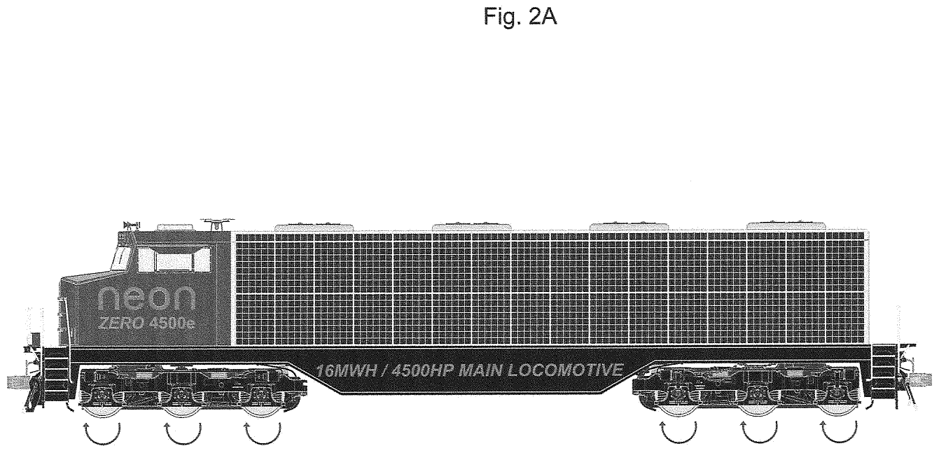

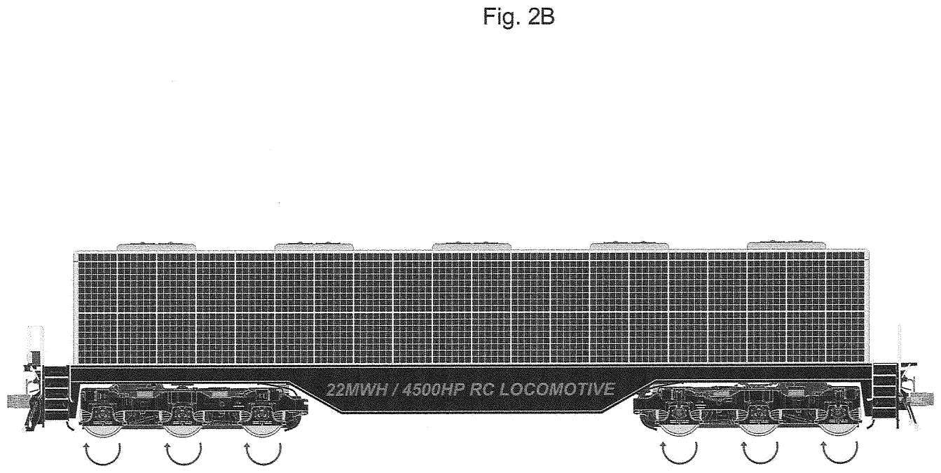

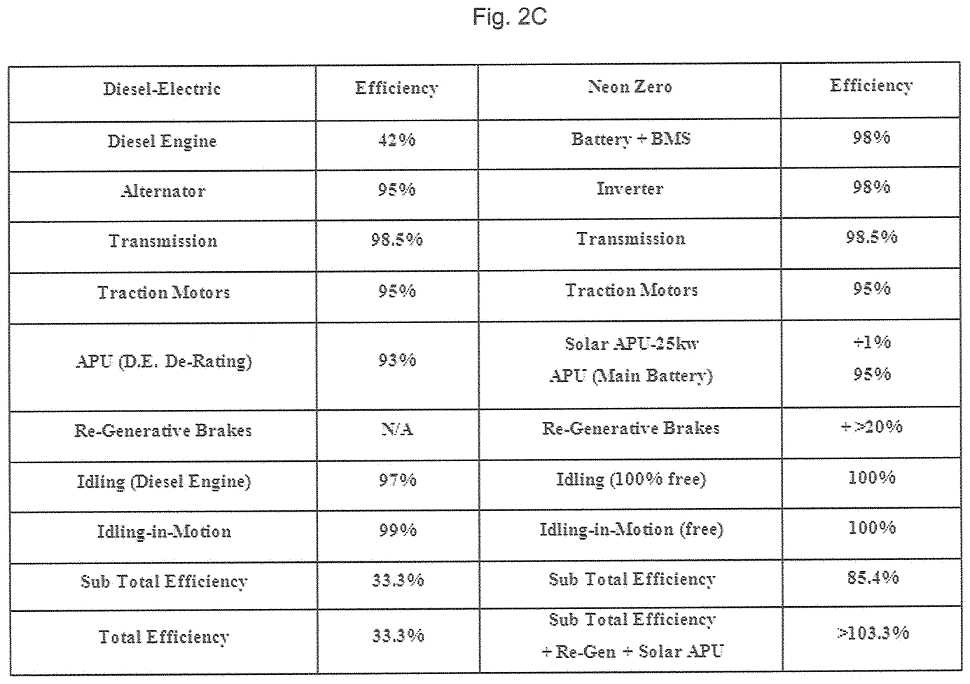

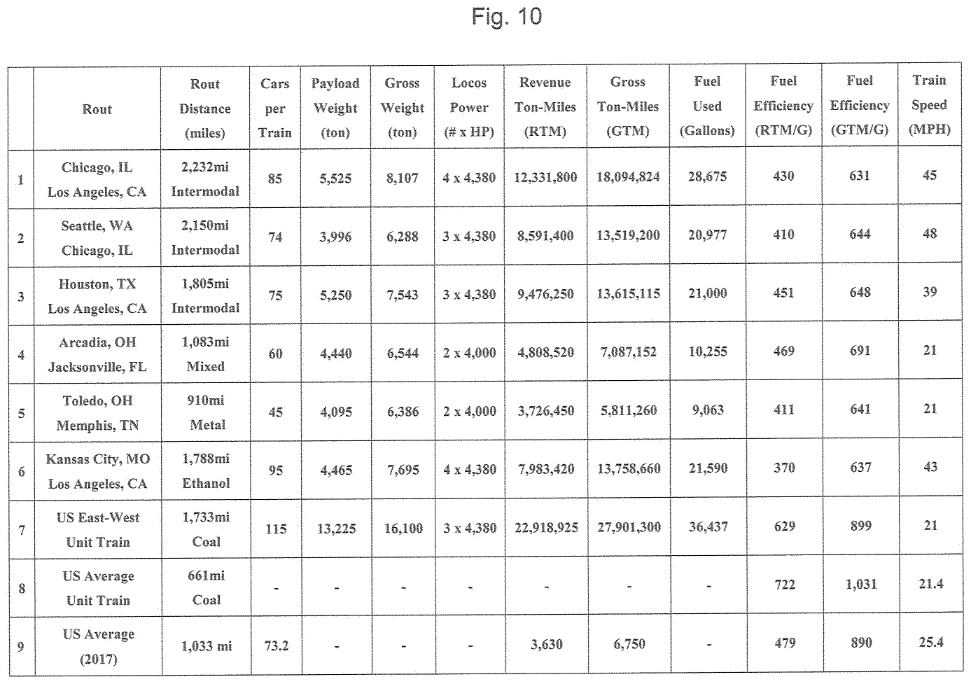

The quantity of electricity needed obtained from the following calculations. As shown in FIG. 10/Row 1, 8,100 GTW Intermodal Train powered by 4 Diesel-Electric locomotives on 2,232 miles long South Trans Con Rout from Los Angeles to Chicago consumes 28,675 gal of diesel fuel. The Neon Zero locomotives have fuel efficiency 3.1 times better (103.3/33.3=3.1) than diesel-electric locomotives (see FIG. 2C), so they will consume 28,675/3.1=9,250 Diesel Fuel Gallon Equivalent of energy. 1 Gallon Diesel Fuel Equivalent (GDFE)=40.65 kwh of electricity.

The electricity consumption by 4 Neon Zero locomotives on same South Trans Con 2,232 mi long rout and same train will be: 9,250×40.65 kwh=376,012 kwh, or 376,012 kwh/2,232 miles=168.5 kwh/mi-train. To travel 275 miles between recharging stations the train consist will need: 168.5 kwh/mi×275 mi=46,330 kwh (46.3 Mwh). For comparison, average US system-wide freight train described in [018] (74.3 cars, 2+ locos, 6750 GTW, 1,033 mi average haul, 25.4 average speed, ˜890 GTM/G fuel efficiency) will use 6,750×1,033/890/3.1×40.65/1,033=99.451 cwh/mi-train of electricity compare to 168.5 kwh/mi-train for BNSF 8,100 GTW Intermodal Train.

The 46.3 Mwh is net electricity consumed by 4 Neon Zero locos. The battery capacity, however, has to be larger to have several reserves. Following reserves have been added: 50 miles/2 Hours distance reserve—8.4 Mwh, State of Charge reduction (SOC 90% vs 100%)—7.4 Mwh, battery aging capacity lost reserve—11.1 mwh (˜15% of initial capacity). Total battery capacity for 4 Neon Zero will be: 46.3 Mwh+8.4 Mwh+7.4 Mwh+11.1 Mwh=73.2 Mwh (73 Mwh rounded). Main 4500e Neon Zero has 48 Battery Racks with 360 NMC-622 940 wh cells each, and stores 16.24 Mwh of energy. The RC 4500e Neon Zero has 64 Battery Racks with 360 NMC-622 940 wh cells, and stores 21.7 Mwh of energy. When used in 4 locos consists with 2 Main+2 RC locomotives they will store total 2×16.2 Mwh+2×21.7 Mwh=75.8 Mwh of energy, which will satisfy battery capacity requirements for the 8,100 GTW Intermodal trains on the S. Trans Con route described above. Such trains are in the top tier of energy consumption in the railroad system, so other trains will be satisfy as well.

As stated before, Neon Zero locomotives have weight limitation for batteries of <105 metric tons per loco. Today best commercially available energy storage batteries, suitable for locomotive applications, have specific energy on racks level of less than 150 wh/kg. 21.7 Mwh Neon Zero battery made from such racks will weight >141 metric tons and not fit into the locomotive. Neon Zero batteries have specific energy on rack level of >215 wh/kg, so the weight of 21.7 Mwh Neon Zero battery is <101 metric tons. Such specific energy is achieved by utilizing new generation of NMC-622 cells with specific energy of >250 wh/kg. (See FIG. 11 for cell specification). Such cells are coming on the market in 2022-2023.

To move next generation of longer and heavier (8000 Ft/10,500 GTW) Intermodal Trains on same S. Trans Con route 5× Neon Zero 4500e locos, or 4 more powerful Neon Zero 6000e locomotives will be needed. The 6000e locomotives will need 1.3 times larger batteries (10,500 T/8,100 T=1.3) with a total capacity of 95 Mwh. Such batteries can be built with next generation of NMC-811 cells with specific energy of >325 wh/kg (See FIG. 12 for cell specification). Main Neon Zero 6000e locomotive has 48 Battery Racks with 360 NMC-811 1200 wh cells each and stores 20.74 Mwh of energy. The RC Neon Zero 6000e has 64 Battery Racks with 360 NMC-811 1200 wh cells each and store 27.65 Mwh of energy.

When used in 4 locos consists with 2 Main+2 RC locomotives they will store a total 2×20.74 Mwh+2×27.65 Mwh=96.8 Mwh of energy. It will satisfy battery capacity requirements for 10,500 GTW Intermodal trains with 4 locomotives described above. The Neon Zero 6000e locomotive battery racks weigh 1570 kg and have a specific energy of 275 wh/kg. The 27.65 Mwh battery of RC Neon Zero weigh is 100.5 t (<105 t limit). NMC-811 cells will be mass produced by 2025.

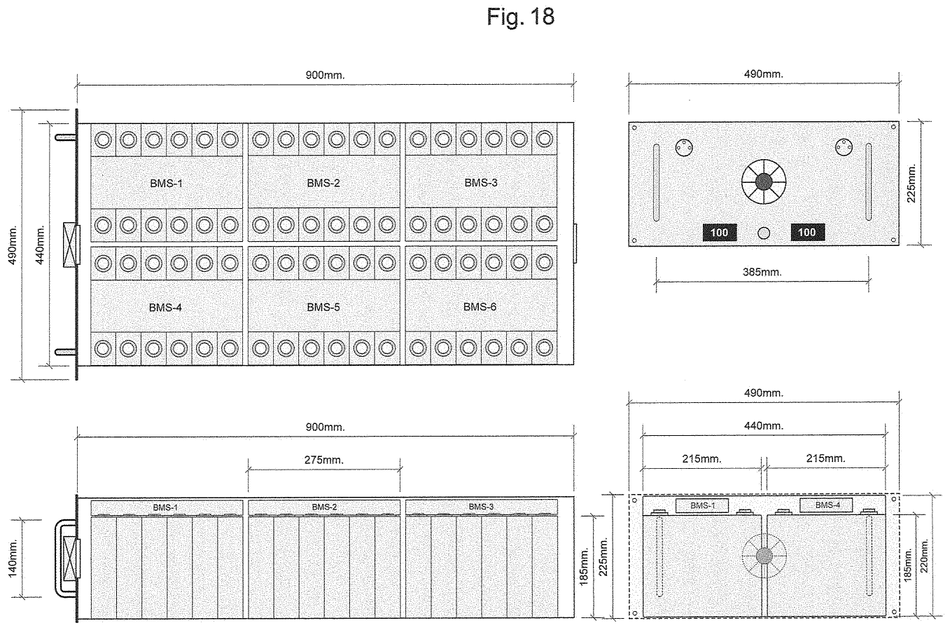

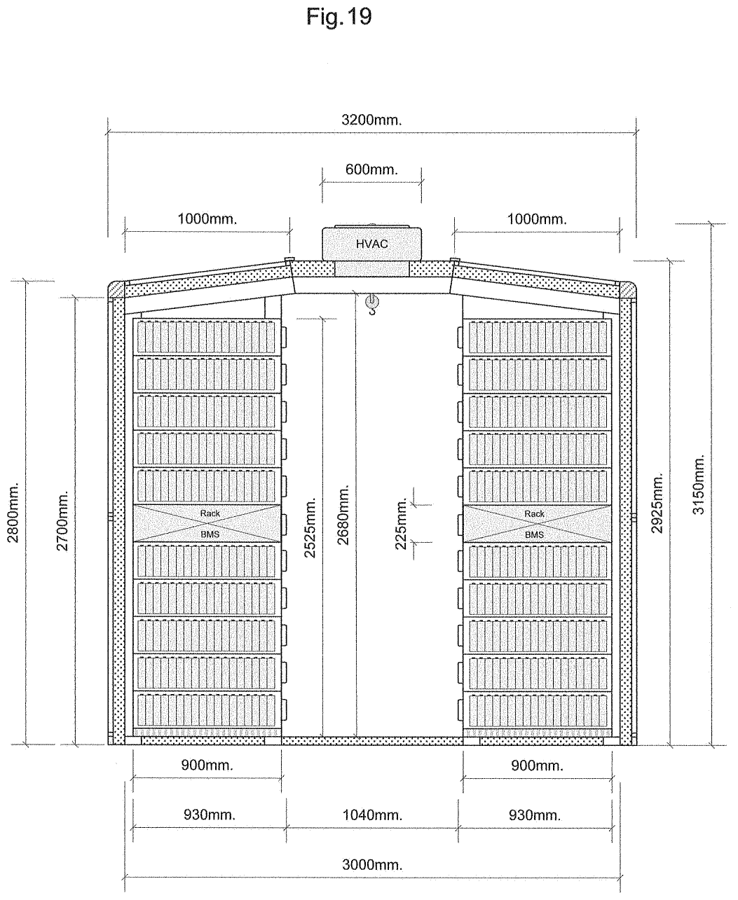

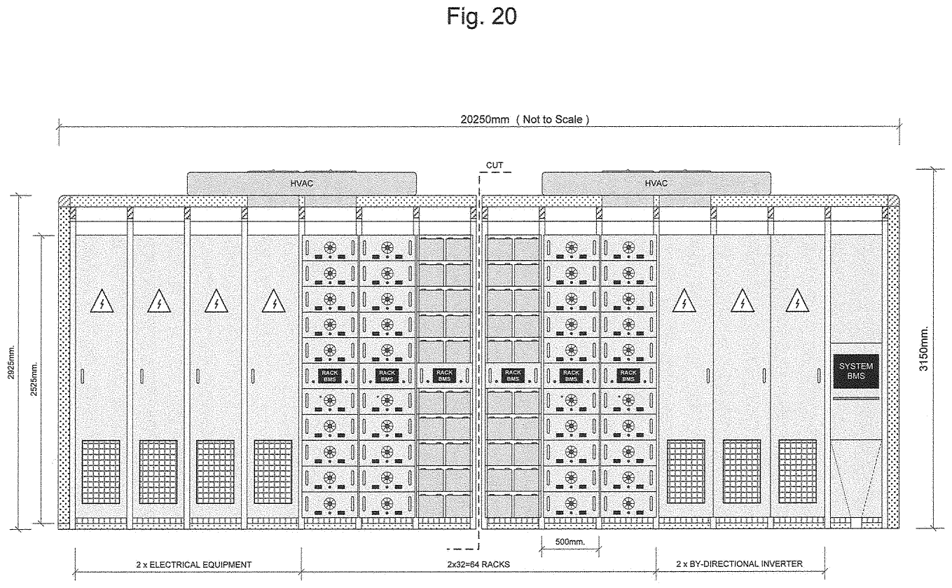

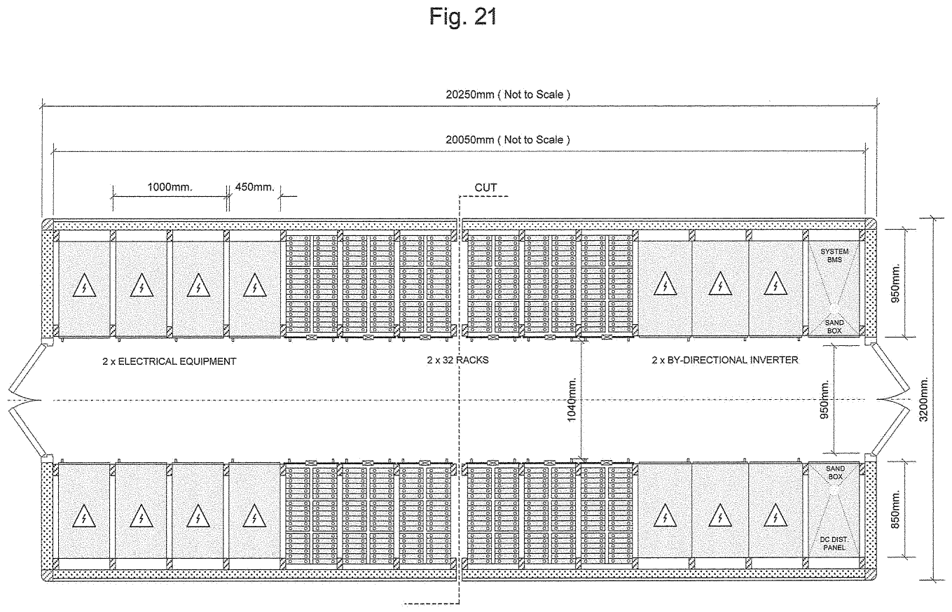

The battery of preferred embodiment comprise of 36 NMC-622 or NMC-811 prismatic cells connected in series and combined in modules, than 10 modules connected in series and combined into the racks with a maximum voltage of 1500V and total stored energy of 338.4 Kwh for NMC-622 cells, or 432 Kwh for NMC-811 cells. Farther, the racks can be connected in series in groups of 2 or 4, and groups connected in parallels to form battery system with maximum voltage of 3000V or 6000V. Drawings of the battery module, rack and battery system are shown in FIG. 18, FIG. 19, FIG. 20, FIG. 21.

### Neon Zero Recharging Infrastructure

The Neon Zero recharging infrastructure doesn't have to be build at once, nor do railroads have to pay for it. Numerous Solar PV and Wind power plants developers with adequate resources will compete to participate in the largest renewable energy project in US history, which may be an integral part of the US plan to overhaul and upgrade national infrastructure. Neon Zero recharging infrastructure will need ˜200 power plants with a total output of >150 GW built over a 15-20 Years period, and the price tag of >$75 Billions. Developers will be interested to participate and finance the project, namely, because the project will provide elevated Return-On-Investment, and possible Federal and State Governments financial incentives. Major contributors to higher ROI will be faster capital turnaround because of simplified, shortened approval process for non-grid connected power plants, no need for traditional transmission lines 20+ years approval process, no need to convert solar panel's DC to AC current, anticipated Federal and State Tax incentives, and other benefits from Public-Private partnerships.

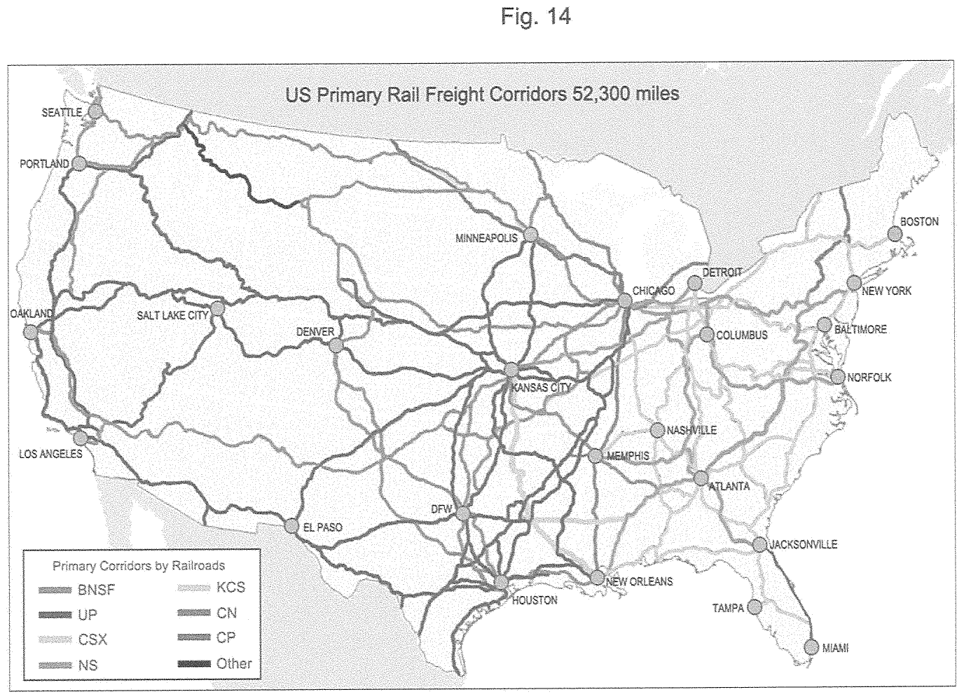

Proposed Neon Zero recharging infrastructure could be built first on 52,300 miles of US Primary Railroad Freight Corridors (see map FIG. 14) in phases corresponding with numbers of Neon Zero locomotives railroads put in service on each specific route. Each of one average trains per day traffic density on particular route will need about 25 Mwh of electricity per day, or ˜5 MW DC rated Solar PV panels or Wind Turbines power plant. So, if route has 50 train/day traffic densities, it will need a 250 MW renewable energy power plant for each recharging station on the route.

Today, very busy BNSF Southern Trans Con Rout has a peak traffic density of ˜100 trains/day and needs 500 MW solar PV or Wind turbine power plant for each of 8 re-charging stations spaced on average at 275 miles on 2230 miles long route from Los Angeles to Chicago. Again it doesn't have to be built at once. Railroads can buy, and manufacturers can make annually only limited numbers of locomotives, currently about 1200 per year. If demand will exist, two locomotive manufactures in US may ramp production to 1500-2000 locos/year, similar to what was done when railroads replaced steam by diesel-electric locomotives with an average replacement rate of 1800+ locos/year.

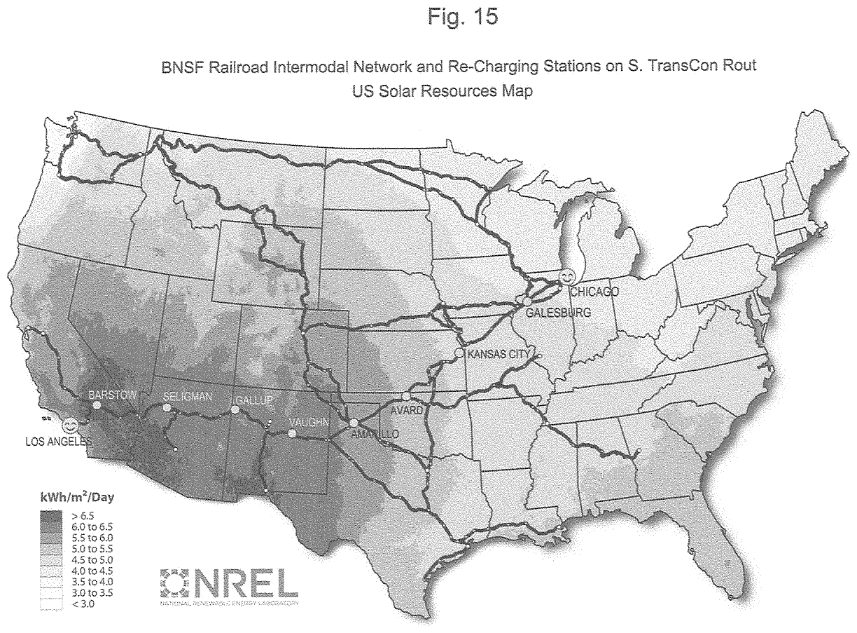

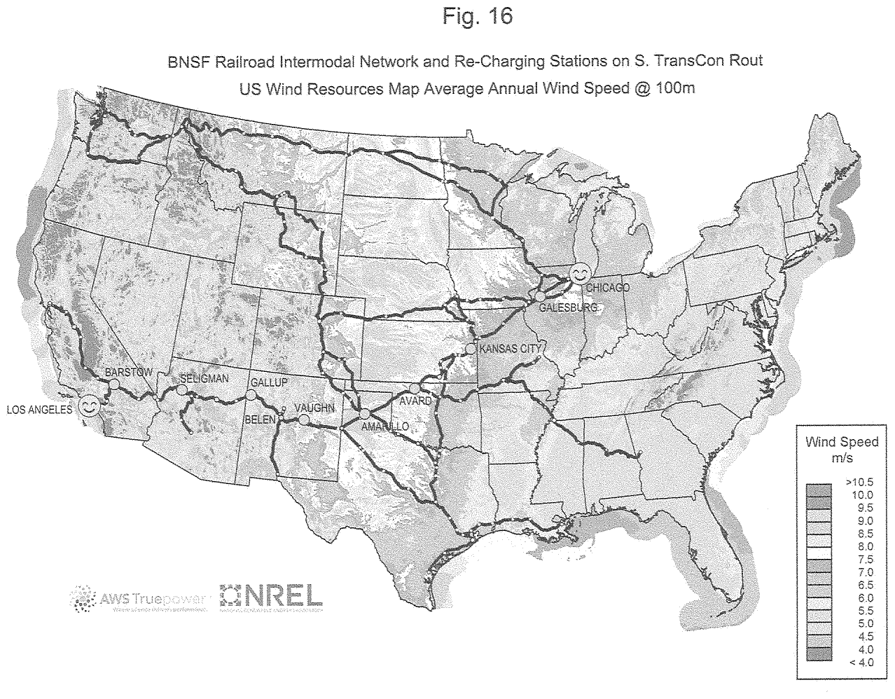

With such a production rate it will take about 15 years to replace 25,000 line haul diesel-electric locomotives in North America. Assuming that a total of 1,200 Neon Zero locomotives can be put in service every year by all Class 1 railroads, and BNSF share will be ˜300 locos/year for Southern Trans Cone Rout alone, 4 GW of new renewable power plants have to be built for this route, or 50 MW/Year for each of 8 re-charging stations during 10 years period of project completion. As an example, FIG. 15 shows BNSF Intermodal Map over US Solar Resources Map, and the possible location of the recharging stations on BNSF S.TransCon Rout. FIG. 16 shows BNSF Intermodal Map over US Wind Resources Map.

### First Preferred Embodiment

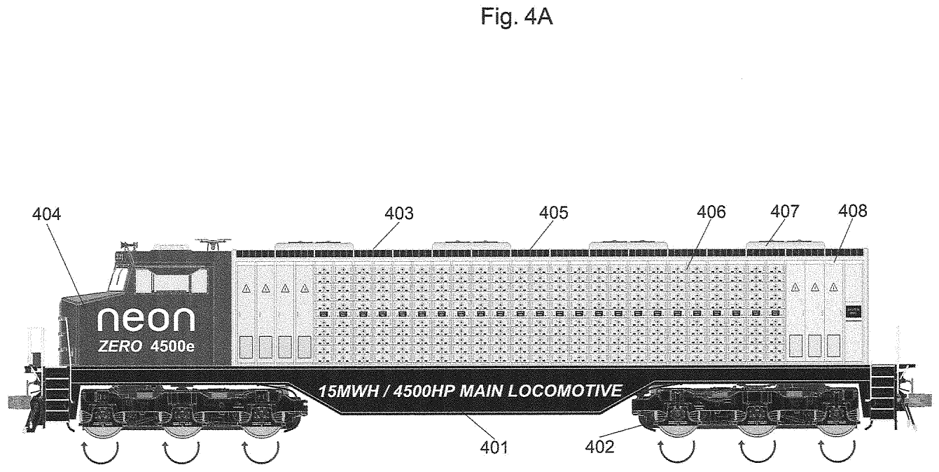

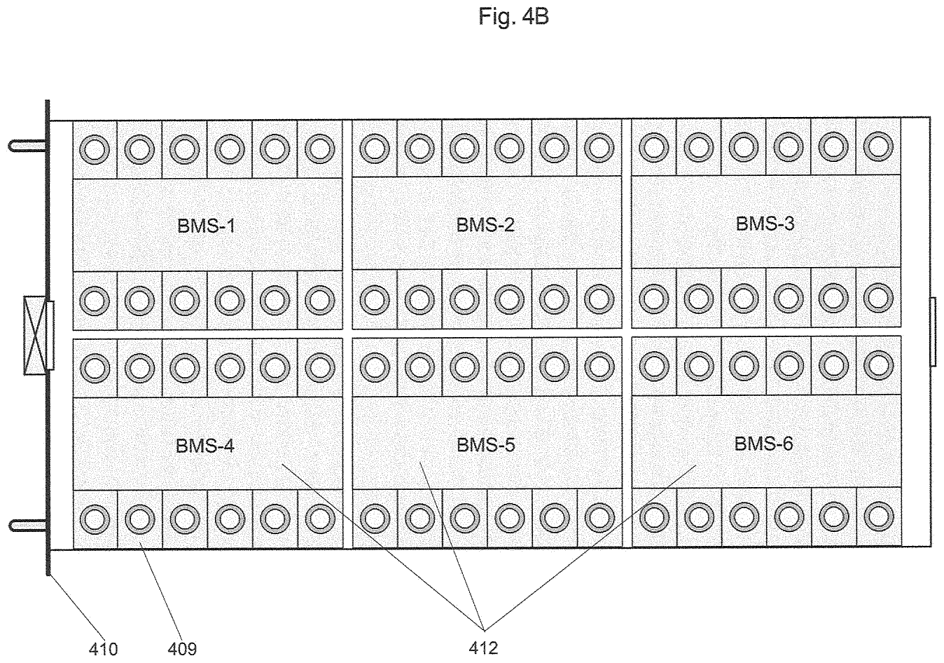

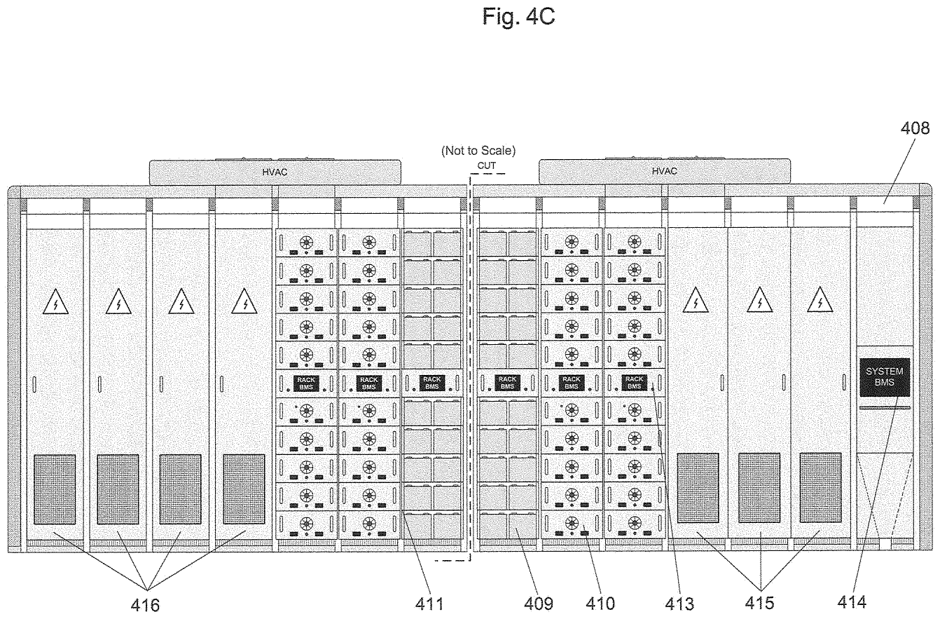

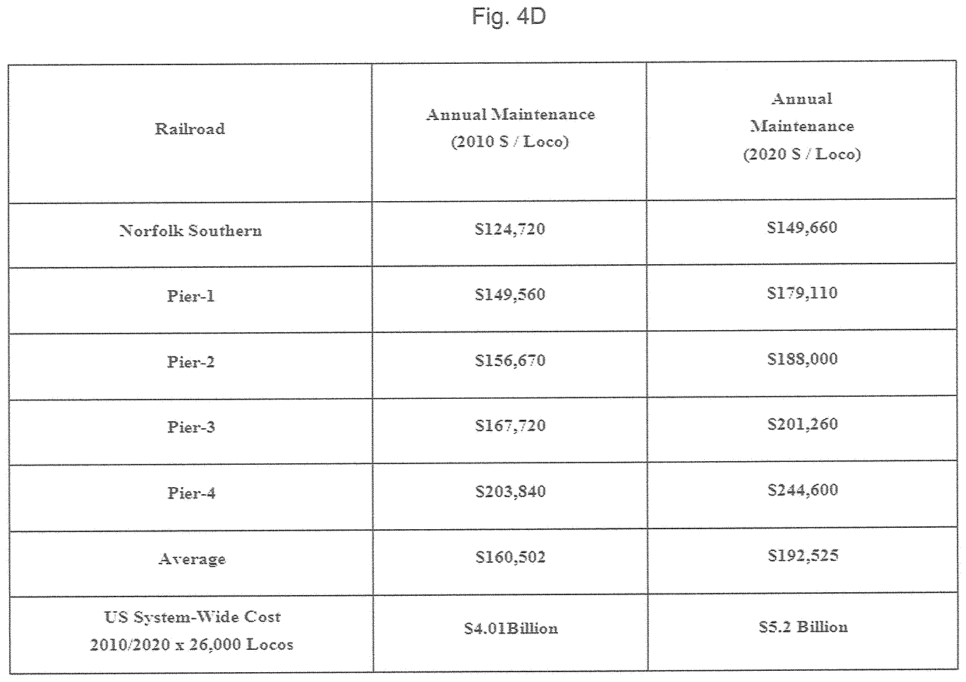

The first preferred embodiment of the Neon Zero 4500e long range battery-electric line-haul locomotive is shown in FIG. 2A, FIG. 2B, FIG. 4A, FIG. 4B, FIG. 4C. The locomotive comprised of 6 axels heavy duty locomotive chassis 401 with maximum axle load of 72,000 lb each, and has maximum Gross Vehicle Weight (GVW) of 432,000 lb. It is powered by 6 AC traction motors 402 (One motor per axel) with a total combined power of 4500 Hp. An insulated locomotive body 403 with crew cabin 404 attached to heavy-duty locomotive chassis 401. An Auxiliary Power Unit (APU) powered by PV solar panels 405 attached to locomotive body 403 and generate approximately 30 KW DC power, stored in locomotive main rechargeable battery 406. A climate control system (HVAC) comprised of 4 roof-top Air Conditioners/Heaters 407 and regulated air-ducts 408.

The main rechargeable battery 406 comprised of 17,280 MNC-622 260 Ah/940 Wh individual prismatic cells 409 with a total storage capacity of 16.24 Mwh, and a weight of 75.5 metric ton. Farther, 36 prismatic cells 409 connected in series and combined into 480 modules 410, than 10 modules 410 connected in series and combined into the 48 racks 411 with rack storage capacity of 338.4 kwh, and maximum system voltage of 1500V. For recharging purposes racks 411 can be farther connected in series and/or parallel, and combined into the groups from 2 to 24 racks.

A main battery 409 has a 3-level battery management system: on cells level 412 (one BMS for 6 cells), on modules level (one per module) 413, and on main battery system. level 414. Six main bi-directional DC-AC/AC-DC power inverters 415 convert main battery 406 DC current into AC current to power AC traction motors 402 via main bus 216, as well as convert AC to DC current from traction motors 402 during regenerative braking. Recovered energy from regenerative brakes stored in main battery 406. The power inverter 415 also converts AC current from ground-based recharging stations to charge main battery 406. Eight electrical equipment control cabinets 416 perform control of electricity flow.

While particular exemplary embodiments have been described and shown in the attached drawings, figures and tables, it is to be understood that such embodiments are illustrative of and not restrictive on the scope of the invention. It will be understood by those skilled in the art that various changes in form and details may be made therein without departing from the essence and scope of the invention. Therefore, the attached claims and their legal equivalents should determine the scope of this invention.

### Conclusion

In view of the above, each of the presently pending claims in this application is believed to be in the immediate condition for allowance. Accordingly, the Examiner is respectfully requested to pass this application to issue. If it is determined that a telephone conference would expedite the prosecution of this application, the Examiner is invited to call my lawyer at phone number presented below.

### Howard M Cohn, Esquire

### Registration No. 25,808

### 30125 Chagrin Blvd, Suite 300

### Cleveland, Ohio 44124

### Phone 216-752-0955

### Fax 866-646-0113

### Respectfully Michael A. Gura, Inventor

I claim:

1. Long range, zero emission, battery-electric main line haul freight locomotive comprising:
a. A 6-Axle/12-Wheel heavy duty locomotive chassis has maximum axle load of 72,000 lb, and maximum Gross Vehicle Weight (GVW) of 432,000 lb;
b. A plurality of electric traction motors with combined power of 2,301 Hp or more;
c. An insulated locomotive body attached to heavy duty locomotive chassis;
d. A crew cabin;
e. A main rechargeable battery comprising from plurality of individual cells combined into modules and racks with total capacity more than 2 Mwh to power electric traction motors;
f A battery management system (BMS);
g. A battery climate control system (HVAC);
h. A main bi-directional DC-AC/AC-DC power inverter;
i. A main bus coupling rechargeable battery with main bi-directional DC-AC/AC-DC power inverter;
j. A traction bus coupling main bi-directional power inverter with plurality of electric traction motors;
k. A traction motors master controller;
l. A locomotive consolidated control system (LCCS)
m. An Auxiliary Power Unit (APU) powered by PV solar panels;
n. An APU solar panels controller/battery charger;
o. A traction motors and power inverter cooling systems;
p. A fire protection system;
q. An electronic air brakes;
r. A regenerative electric brakes;
s. A regenerative brakes rechargeable buffer battery with battery management system (BMS);
t. A no idling-in-motion adaptive cruise control (NOIIM-ACC);
u. A locomotive situation awareness system (LSAS) comprising of multiple video cameras, night vision cameras, LIDAR, GPS, video link, communication system, and RC electric multi-rotor drone;
v. A locomotive centralized remote control system (CRCS);
w. A trains platoon control system (TPCS) allowing multiple trains to be driven synchronously as a single unit;
x. A locomotive autonomous driving system (LADS);
y. A locomotive positive train control system (LPTCS);
z. A sandboxes traction control;

2. The locomotive according to claim 1, wherein said 6-Axle heavy duty locomotive chassis has maximum axle load of 79,000 lb, and maximum Gross Vehicle Weight (GVW) of 474,000 lb;

3. The locomotive according to claim 1, wherein said 4-Axle medium duty locomotive chassis has maximum axle load of 72,000 lb, and maximum Gross Vehicle Weight (GVW) of 288,000 lb, with combined electric traction motors power more than 2,301 Hp and less than 4,000 Hp;

4. The locomotive according to claim 3, wherein said 4-Axle medium duty locomotive chassis has maximum axle load of 79,000 lb, and maximum Gross Vehicle Weight (GVW) of 316,000 lb;

5. The locomotive according to claim 1, wherein said freight locomotive configured to be used as a short line-haul or yard switcher locomotive;

6. The locomotive according to claim 1, wherein said freight locomotive configured to be used in passenger service;

7. The locomotive according to claim 1, wherein said freight locomotive built on used remanufactured diesel-electric locomotive chassis;

8. The locomotive according to claim 1, wherein said 8-Axel super heavy duty locomotive chassis has maximum axle load of 72,000 lb, and maximum Gross Vehicle Weight (GVW) of 576,000 lb, with combined electric traction motors power more than 4,000 Hp;

9. The locomotive according to claim 1, wherein said 8-Axle or more super heavy duty locomotive chassis has maximum axle load of 79,000 lb or more, and maximum Gross Vehicle Weight (GVW) of 632,000 lb or more, with combined electric traction motors power of 4,000 Hp or more;

10. The locomotive according to claim 1, wherein said locomotive has no crew cabin, and remotely controlled (RC) by crew from master locomotive, when said RC locomotive used in same train consist;

11. The RC locomotive according to claim 10, wherein said RC locomotive has additional manual control;

12. The locomotive according to claim 1, wherein said one or more additional rechargeable batteries located on separate heavy or medium duty chassis with no propulsion means (battery tender), said temporarily attached to the locomotive in order to increase total battery capacity;

13. The battery tender according to claim 12, wherein said tender rechargeable battery of any known or future chemistry or type, has capacity more than 1 Mwh per tender, or combined capacity more than 2 Mwh of all battery tenders in train consist;

14. The battery tender according to claim 12, wherein said one or more battery tenders coupled to one or more diesel-electric locomotives in order to provide battery storage for electricity generated by regenerative brakes on diesel-electric locomotives;

15. The locomotive according to claim 1, wherein said plurality of electric traction motors are AC type;

16. The locomotive according to claim 1, wherein said plurality of electric traction motors are DC type;

17. The locomotive according to claim 1, wherein said plurality of electric traction motors are less than full set of axels;

18. The locomotive according to claim 17, wherein said 6 axel locomotive have 4 powered axel with combined electric traction motors power more than 2,301 Hp and less than 4,000 Hp;

19. The locomotive according to claim 17, wherein said 4 axel locomotive has 2 powered axel with combined electric traction motors power less than 2,301 Hp;

20. The locomotive according to claim 1, wherein said rechargeable locomotive battery of any known or future chemistry or type, has capacity more than 1 Mwh per locomotive;

21. The locomotive according to claim 1, wherein said more than one locomotive used in same train consist, and said rechargeable locomotive batteries of any known or future chemistry or type, have combined capacity more than 2 Mwh per train consist;

22. The locomotive according to claim 1, wherein said one or more locomotives, and said one or more battery tenders used in same train consist, and said rechargeable locomotive or tender batteries of any known or future chemistry or type, have combined capacity more than 2 Mwh per train consist;

23. The locomotive according to claim 1, wherein said one or more locomotives coupled to one or more diesel-electric locomotives to form Mixed Multi-Unit (MMU) locomotive consist in order to provide battery storage for electricity generated by regenerative brakes on diesel-electric, or battery-electric or both types of locomotives in Mixed Multi-Unit (MMU) consists;

24. The locomotive according to claim 23, wherein said rechargeable battery of any known or future chemistry or type, has capacity more than 1 Mwh per battery-electric locomotive or combined capacity more that 2 Mwh of all battery-electric locomotives in mixed Multi-Unit (MMU) locomotive consists;

25. The locomotive according to claim 1, wherein said rechargeable battery cells used in rechargeable locomotive or tender batteries of any known or future chemistry or type, have Specific Energy of 80 wh/kg or more on cells level, or module/battery level, if module/battery has only one cell;

26. The locomotive according to claim 1, wherein said rechargeable locomotive or tender battery has standard charging rating of 0.5 C or more, and can be fully charged from 0% to 100% SOC in 2 hour or less;

27. The locomotive according to claim 1, wherein said rechargeable locomotive or tender battery has standard discharge rating more than 0.1 C, and can be fully discharged from 100% to 0% SOC in 10 hour or less;

28. The locomotive according to claim 1, wherein said rechargeable locomotive or tender battery has 1,000 or more charge/discharge life cycles at 0.5 C charge/0.5 C discharge rate, and 100% state of charge/discharge at room temperature, and will retain 80% or more of initial rated capacity;

29. The locomotive according to claim 1, wherein said rechargeable locomotive or tender battery has more than 3,000 charge/discharge life cycles at 1 C charge/1 C discharge rate, and 100% state of charge/discharge at room temperature, and will retain 80% or more of initial rated capacity;

30. The locomotive according to claim 1, wherein said rechargeable locomotive or tender battery has life span of 5 years or more and will retain 80% or more of initial rated capacity under standard SOC-SOD conditions;

31. The locomotive according to claim 1, wherein said rechargeable locomotive or tender battery is Lithium Nickel Manganese Cobalt (LNMC) cathode chemistry with high proportion of nickel and low proportion of cobalt content;

32. The locomotive according to claim 31, wherein said rechargeable locomotive or tender battery is Lithium Nickel Manganese Cobalt (LNMC) cathode chemistry, and Graphite, Graphite-Silicon Mix, Silicon, Silicon Alloys, Lithium Metal, Lithium Alloys or LTO (Lithium Titanate Oxide) anode;

33. The rechargeable locomotive or tender battery according to claim 31, wherein said locomotive or tender battery has cathode with high nickel & low cobalt content with rounded nickel, manganese & cobalt content proportion of close to 9-0.5-0.5, 8-1-1, 7-2-1, 6-3-1, 6-2-2, 5-4-1, 5-3-2, 4-4-2, 4-5-1, 4-3-3, known as LNMC90, LNMC 811, LNMC 721, LNMC 631, LNMC 622, LNMC 541, LNMC 532, LNMC 442, LNMC 451, LNMC 433 battery chemistry;

34. The locomotive according to claim 1, wherein said rechargeable locomotive or tender battery is Lithium Nickel Cobalt Aluminum (LNCA) cathode chemistry with any high proportion of nickel, and low proportion of cobalt content;

35. The locomotive according to claim 34, wherein said rechargeable locomotive or tender battery is Lithium Nickel Cobalt Aluminum (LNCA) cathode chemistry, and Graphite, Graphite-Silicon Mix, Silicon, Silicon Alloys, Lithium Metal, Lithium Alloys or LTO (Lithium Titanate Oxide) anode;

36. The rechargeable locomotive or tender battery according to claim 34, wherein said locomotive or tender battery has high nickel & low cobalt content with rounded nickel, aluminum and cobalt content proportion of close to 9-0.5-0.5, 8-1-1, 7-2-1, 6-3-1, 6-2-2, 5-4-1, 5-3-2, 4-4-2, 4-5-1, 4-3-3 known as LNCA 90, LNCA 811, LNCA 721, LNCA 631, LNCA 622, LNCA 541, LNCA532, LNCA 442, LNCA 451, LNCA 433 battery chemistry;

37. The locomotive according to claim 1, wherein said rechargeable locomotive or tender battery is Lithium Nickel Cobalt Manganese Aluminum (LNCMA) cathode chemistry with high proportion of nickel and low proportion of cobalt content;

38. The locomotive according to claim 37, wherein said rechargeable locomotive or tender battery is Lithium Nickel Cobalt Manganese Aluminum (LNCMA) cathode chemistry with rounded 2 part of cobalt content or less, and Graphite, Graphite-Silicon Mix, Silicon, Silicon Alloys, Lithium Metal, Lithium Alloys or LTO (Lithium Titanate Oxide) anode;

39. The locomotive according to claim 1, wherein said rechargeable locomotive or tender battery is Lithium Iron Phosphate (LFP) chemistry a.k.a. LiFePo4, and Graphite, Graphite-Silicon Mix, Silicon, Silicon Alloys, Lithium Metal, Lithium Alloys or LTO (Lithium Titanate Oxide) anode;

40. The locomotive according to claim 1, wherein said rechargeable locomotive or tender battery is Lithium Titanate Oxide (LTO) cathode chemistry, and any known or future anode material;

41. The locomotive according to claim 40, wherein said rechargeable locomotive or tender battery is Lithium Titanate Oxide (LTO) cathode chemistry, and Graphite, Graphite-Silicon Mix, Silicon, Silicon Alloys, Lithium Metal, Lithium Alloys or LTO (Lithium Titanate Oxide) anode;

42. The locomotive according to claim 1, wherein said rechargeable locomotive or tender battery has Conversion Type Cathode of Lithium Metal-Fluoride chemistry, and any known or future anode material;

43. The locomotive according to claim 42, wherein said rechargeable locomotive or tender battery is Lithium Iron-Fluoride or Copper Fluoride cathode chemistry, and Graphite-Silicon Mix, Silicon, Silicon Alloys, Lithium Metal, Lithium Alloys or LTO (Lithium Titanate Oxide) anode;

44. The locomotive according to claim 1, wherein said rechargeable locomotive or tender battery has Conversion Type Cathode of Lithium Sulfur chemistry, and any known or future anode material;

45. The locomotive according to claim 44, wherein said rechargeable locomotive or tender battery is Lithium Sulfur cathode chemistry, and Graphite-Silicon Mix, Silicon, Silicon Alloys, Lithium Metal, Lithium Alloys or LTO (Lithium Titanate Oxide) anode;

46. The locomotive according to claim 1, wherein said rechargeable locomotive or tender battery is Semi-Solid Dual Electrolyte type cathode, and Lithium Iron Phosphate (LFP) or Nickel Manganese Cobalt Oxide (NMC) chemistry;

47. The locomotive according to claim 1, wherein said rechargeable locomotive or tender battery is All-Solid State Battery (ASSB) type with solid cathode, solid ion-conducting electrolyte and solid anode, all of same or different chemistries;

48. The locomotive according to claim 1, wherein said rechargeable locomotive or tender battery cells utilize large format prismatic, pouch or cylindrical housing;

49. An energy train comprising of plurality of battery electric locomotives according to claim 1, and plurality of battery tenders according to claim 12, assembled in train consist to move and distribute electric energy over the railroad routs from power generating plants to recharging stations, or grid substations with no need for electric transmission lines;

50. The energy train according to claim 49, wherein said energy train comprising from at least one battery powered electric locomotive of claim 1, and at least one battery tender of claim 12;

51. The energy train according to claim 49, wherein said train consist comprising of plurality of battery tenders and battery electric locomotives with total battery capacity more than 1,000 Mwh (1 Gwh);

52. A recharging infrastructure to provide source of outside power to recharge locomotives of claim 1, and battery tenders of claim 12 comprising:
a. A recharging stations distributed along a railroad routs, and located on railroad's property;
b. A recharging stations side rails to hold trains in need of stationary recharging;
c. A short overhead or 3d rail power line, for non-stop in motion recharging;
d. A battery chargers and connecting equipment to connect the chargers to locomotives or battery tenders;
e. A plurality of off-grid power generating plants located in close proximity to recharging stations;
f A short transmission lines connecting power generating plants to recharging stations;
g. The energy trains according to claim 49;
h. A recharging station's connection to the public power grid in order to sell excessive power capacity;

53. The recharging station according to claim 52, wherein said recharging stations spaced along railroad routs about every 300 miles, equivalent of about 12 hours freight train travel time between recharging, and equal to maximum allowable on-duty time for train crew;

54. The recharging stations according to claim 52, wherein said recharging stations placed at same locations as train crew replacement and train inspection;

55. The plurality of power generating plants according to claim 52, wherein said power plants are zero emission plants, utilizing renewable energy sources to generate electric power;

56. The plurality of battery tenders delivered to recharging stations from remote power generating plants by energy train according to claim 49, wherein said provide source of outside electric power at recharging stations;

57. The plurality of power generating plants according to claim 55, wherein said power plant is PV solar panels type;

58. The plurality of power generating plants according to claim 55, wherein said power plant is wind turbines type;

59. The plurality of power generating plants according to claim 55, wherein said power plant is hydro-electric type;

60. The plurality of power generating plants according to claim 55, wherein said power plant use battery energy storage to eliminate intermittence of renewable energy and provide power to recharging stations 24 hours/day;

61. The plurality of power generating plants according to claim 52, wherein said power plant is natural gas with CO2 sequestration type;

62. The plurality of power generating plants according to claim 52, wherein said public utility grids provide source of outside electric power to recharging stations;

63. The recharging infrastructure according to claim 52, wherein said the short transmission lines connecting power generating plants to recharging stations have typical length from 1 to 10 miles;

64. An insulated locomotive body according to claim 1, wherein said the locomotive body is light weight, semi-monocoque or monocoque type, insulated by Structural Insulated Panels (SIP);

65. The insulated locomotive body according to claim 64, wherein said locomotive body equipped with plurality of heating, ventilation, air conditioning (HVAC) units and controlled air ducts to provide optimal constant working temperature for battery cells in wide range of outside temperature conditions;

66. The locomotive according to claim 1, wherein said battery management system (BMS) comprising:
a. A computer comprising of CPU, memory, operating system (software), sensor's data analyzing algorithm (software), communication protocol, plurality of monitors, input and output interfaces;
b. A plurality of temperature, pressure, voltage, and current sensors to provide information to BMS computer on temperature, pressure, state of charge (SOC), depth of discharge (DOD) and state of health (SOH) of each cell, module, and rack of the locomotive's or battery tender's rechargeable battery;
c. A plurality of battery cell active balancers, comprising of small bi-directional DC-DC converters to perform redistribution of energy between unevenly charged battery cells;
d. A plurality of battery modules active balancers, comprising of bi-directional DC-DC converters to perform redistribution of energy between unevenly charged battery modules;
e. A plurality of battery rack active balancers, comprising of bi-directional DC-DC converters to perform redistribution of energy between unevenly charged battery racks;
f. The BMS computer controls SOC and DOD of the rechargeable battery in accordance with pre-set parameters and sensor's data, by issuing control command to abort battery charging when pre-set SOC reached, or warning that battery has low charge left and has to be recharged;
g. The BMS computer controls recharging of the battery from regenerative brakes by issuing control commands to the bi-directional main DC-AC/AC-DC power inverter to redirect recovered energy back into the locomotive rechargeable battery;
h. The BMS computer controls the temperature inside the insulated locomotive body and each battery racks in accordance with pre-set parameters and temperature sensor's data, by issuing control commands to the plurality of heating, ventilation, air conditioning (HVAC) units and controlled air ducts;
i. The BMS computer controls SOH of the rechargeable battery cells, modules and racks in accordance with pre-set parameters and sensor's data, by issuing control commands to disconnect unhealthy or damaged unit, and warning for maintenance or replacement;

67. The locomotive according to claim 1, wherein said locomotive consolidated control system (LCCS) monitors and controls all locomotive functions and comprising:
a. A computer comprising of CPU, memory, operating system (software), communication protocol, plurality of smart displays, input and output interfaces;
b. A protocol translator interface;
c. A local area data network (LADN);
d. A plurality of controllers/control panels (included, but not limited) such as:
Traction motors controller (TMC),
Traction blower controller (TBC),
Bi-directional main DC-AC/AC-DC power inverter controller (PIC)
Power inverter blower controller (PIBC),
Battery management system panel (BMSP),
Battery climate control system panel (HVAC-P),
Regenerative electric brakes controller (REBC),
Regenerative brakes buffer battery controller (RBBBC)
Electronic air brakes controller (EABC),
Auxiliary Power Unit controller (APUC),
Centralized remote control system panel (CRCS-C),
Multi-Unit remote control system panel (MU-RCP)
Video link, Communication and GPS system panel (VLC-GPS),
Maintenance and diagnostic system panel (MDSP)
Event recorder system panel (ERSP)
End-of-Train system panel (EOTSP)

68. The locomotive according to claim 1, wherein said Auxiliary Power Unit (APU) comprising:
a. A plurality of PV solar panels attached to insulated locomotive body outside surfaces;
b. A PV solar panels controller/battery charger coupled to locomotive rechargeable battery via main bus;

69. The locomotive according to claim 68, wherein said plurality of PV solar panels are high efficiency, shading tolerated, extended durability Cadmium Telluride (CdTe) thin film type panels;

70. The locomotive according to claim 1, wherein said Regenerative Electric Brakes (REB) comprising:
a. A plurality of locomotive traction motors temporarily reconfigured to work as a power generators;
b. A regenerative electric brake controller, as a part of locomotive consolidated control system (LCCS);
c. A LCCS computer algorithm (software) prioritizing use of regenerative brakes over electronic air brakes in order to convert kinetic train energy into storable electric energy;
d. A locomotive main rechargeable battery to store recovered train's kinetic energy;
e. A regenerative brakes rechargeable buffer battery (RBRBB) for temporarily storage of recovered energy;
f A rechargeable buffer battery charger;
g. A rechargeable buffer battery management system (RBBMS);

71. The regenerative brakes rechargeable buffer battery (RBBMS) according to claim 70, wherein said the buffer battery is high power density, high charge/discharge life cycles type and has capacity from about 1% to 5% of main locomotive rechargeable battery;

72. The rechargeable buffer battery according to claim 70, wherein said the buffer battery has standard charging rating of 6C or more, and can be charged to 100% SOC in 10 minutes or less;

73. The rechargeable buffer battery according to claim 70, wherein said the buffer battery has 10,000 or more charge/discharge life cycles at 6 C charge/3 C discharge rate;

74. The rechargeable buffer battery according to claim 70, wherein said the buffer battery is Lithium Titanate Oxide/Li4Ti5O12 (LTO) cathode chemistry;

75. The rechargeable buffer battery according to claim 70, wherein said the buffer battery is Lithium Ion Super Capacitor (LISC) type;

76. The locomotive according to claim 1, wherein said locomotive centralized remote control system (CRCS) comprising:
a. A ground based centralized control center(s) with multitude of train drivers/engineers remotely controls and drives multiple trains each;
b. A driver/engineers control consoles, duplicating similar console in the locomotive cabin, connected to the locomotive consolidated control systems (LCCS) by direct communication link;
c. A large format video monitor at each control console connected to the locomotive situation awareness system (LSAS) by direct video link;
d. A locomotive situation awareness system (LSAS) comprising of multiple video cameras, night vision cameras, LIDAR, GPS, sound and weather sensors, video link, communication system, an autonomous multi-rotor drone;

77. The locomotive according to claim 1, wherein said locomotive autonomous driving system (LADS) comprising
a. A locomotive super computer (LSC) with artificial intelligence software (AI);
b. A set of sensors included in locomotive situation awareness system (LSAS);
c. A locomotive positive train control system (LPTCS);
d. A no idling-in-motion adaptive cruise control (NIM-ACC);

78. The locomotive according to claim 1, wherein said locomotive positive train control system (LPTCS) comprising:
a. A locomotive speed control unit (LSCU);
b. A locomotive navigation system and track profile database;
c. A bi-directional data link to inform signaling equipment of the train's presence;
d. A wireless or wired communication channels to dynamically inform the speed control unit of changing track or signal conditions;
e. A locomotive centralized remote control system (CRCS), or locomotive autonomous driving system (LADS) directly issuing movement authorities to the trains;

79. The locomotive according to claim 1, wherein said trains platoon control system (TPCS), allowing multiple trains to be driven in synchronous manner as a single unit (platoon), with substantially reduced distance between trains;

80. The trains platoon control system (TPCS) according to claim 79, wherein said trains platoon movement control performed by single driver/engineer located in main locomotive cabin of the first train in platoon;

81. The trains platoon control system (TPCS) according to claim 79, wherein said trains platoon movement control performed by single driver/engineer utilizing locomotive centralized remote control system (CRCS);

82. The trains platoon control system (TPCS) according to claim 79, wherein said trains platoon movement control performed by locomotive autonomous driving system (LADS) without a driver's active control;

83. Method of freight trains operation comprising:
a. A plurality of freight railroad cars combined in train consists with gross weight from 1,000 to 25,000 ton;
b. At least one battery-electric main line haul locomotive according to claim 1 per train consist;
c. A plurality of remotely controlled (RC) battery-electric line haul locomotives according to claim 10;
d. A plurality of battery tenders according to claim 12;
e. A recharging infrastructure distributed along a railroad routs according to claim 52;
f. A plurality of zero emission power plants located in close proximity to recharging stations according to claim 55;
g. A plurality of zero emission power plants and energy trains provide virtually 100% zero emission operation;
h. At least one ground based centralized control center according to claim 76;

84. Method of freight trains operation according to claim 83, wherein said typical US train consist will have 70 to 125 cars, will be 6000 ft to 8000 ft long, and has 5,000 to 25,000 ton gross weight;

85. Method of freight trains operation according to claim 83, wherein said typical US train consist will have 3 battery-electric locomotives with total battery capacity of 60-90 Mwh (20-30 Mwh per locomotive) and no battery tenders;

86. Method of freight trains operation according to claim 83, wherein said recharging stations spaced on average about 300 miles (8 to 12 hour travel time between recharging), and will recharge locomotive batteries in 30 to 45 minutes;

87. Method of freight trains operation according to claim 83, wherein said any train consist will have US Cost-to Cost range, limited only by recharging infrastructure availability, but not limited by train size, weight or speed;

88. Method of freight trains operation according to claim 83, wherein said average US freight railroad train consist (73.2 cars/7,000 gross ton weight) will have fuel efficiency about 1,450 Revenue Ton-Miles/Gallon-Equivalent of diesel fuel, or about 3.1 times better than similar train powered by diesel-electric locomotives (about 470 RTM/gallon);

89. Method of freight trains operation according to claim 83, wherein said cost of electricity will be fixed through long term (20+ years) Power Purchase Agreement (PPA), and will eliminate fuel price volatility typical for diesel-electric locomotives operation;

90. Method of freight trains operation according to claim 83, wherein said cost of electricity will be below $0.04/kwh in 2020 USD (less than $1.7 per gallon-equivalent of diesel fuel) compare to $2.83/gallon (10 years US system-wide average diesel fuel cost in 2020 USD);

91. Method of freight trains operation according to claim 83, wherein said annual cost of fuel will be about $101,000/year for battery-electric locomotive compare to about $515,000/year for diesel locomotive, or US system-wide savings of $8+ billion/year for 20,000 line haul locomotives, or $240 bill over 30 years locomotive life span (in 2020 USD);

92. Method of freight trains operation according to claim 83, wherein said absolute zero emission operation will eliminate US system-wide use of about 3.6 billion gallons/year of diesel fuel, and replace over 150 Gw of coal and natural gas burning power plants capacity;

93. Method of freight trains operation according to claim 83, wherein said absolute zero emission operation will eliminate US system-wide about 50 million ton/year greenhouse gases (CO2) and other pollutants from 20,000 locomotives, and about 150 million ton/year from power plants, worth $5+ billion/year in possible Federal and State Tax Credits and other incentives, or about $150 billion over 30 years period (in 2020 USD);

94. Method of freight trains operation according to claim 83, wherein said locomotive maintenance will be reduced more than 2 times from about 1300 man-hrs/year for diesel-electric to about 600 man-hrs/year for battery-electric locomotive, or from about $195,000/year to $85,000/year per locomotive, or US system-wide savings of more than $2+ billion/year for 20,000 line haul locomotives, or $60+ billion over 30 years locomotive life span (in 2020 USD);

95. Method of freight trains operation according to claim 83, wherein said multiple trains, typically 2 to 6, remotely operated by single driver/engineer from ground based centralized control center, and one or no cabin crew member (conductor/operator), which will provide US system-wide savings from $1.5 billion/year to $2.5 billion/year in labor cost, or from $45 billion to $75 billion over 30 years locomotive life span (in 2020 USD);

96. Method of freight trains operation according to claim 83, wherein said train control performed by locomotive autonomous driving system (LADS) and one or no cabin crew member (conductor), which will provide system-wide savings about $3 billion/year in labor cost, or $90 billion over 30 years locomotive life span (in 2020 USD);

97. Method of freight trains operation according to claim 93, wherein said multiple trains, typically 2 to 6, moving in synchronous manner as a single unit (platoon) with reduced distance between trains and increased train speed, therefore increasing existing railroad tracks capacity up to 25+%, and reducing necessary $3-$5 billion/year capital investment to increase railroads capacity, or $100-$150 Billion savings over 30 Years (in 2020 USD);

98. Method of freight trains operation according to claim 83, wherein said upon implementation of the method on 52,300 miles US primary railroad freight corridors alone, combined US system-wide savings can be as high as $25 billion/year, or $750 billion over 30 years battery-electric locomotive life span (in 2020 USD;
